(19) United States
(12) Patent Application Publication
(10) Pub. No.: US 2009/0254801 A1
(43) Pub. Date: Oct. 8, 2009

(54) MODEL NAVIGATION

(75) Inventors: Eric PRESSMAN, Needham, MA (US); Jay Ryan TORGERSON, Hopkinton, MA (US); Pieter J. MOSTERMAN, Framingham, MA (US)

Correspondence Address: LAHIVE & COCKFIELD, LLP/THE MATHWORKS;FLOOR 30, SUITE 3000, One Post Office Square, Boston, MA, 02109-2127, US

(73) Assignee: THE MATHWORKS, INC., Natick, MA (US)

(21) Appl. No.: 12/484,798

(22) Filed: Jun. 15, 2009

Related U.S. Application Data
(63) Continuation-in-part of application No. 11/820,154, filed on Jun. 18, 2007.
Application No. 11/820,154 is a continuation-in-part of application No. 11/359,342, filed on Feb. 22, 2006, now Pat. No. 7,555,731.
Application No. 11/820,154 is a continuation of application No. 10/748,064, filed on Dec. 29, 2003, now Pat. No. 7,337,102.
Application No. 11/359,342 is a continuation of application No. 09/858,141, filed on May 14, 2001, now Pat. No. 7,010,744.
(60) Provisional application No. 61/184,575, filed on Jun. 5, 2009.

(51) Int. Cl. G06F 3/048; G06F 17/00

(52) U.S. Cl. 715/205; 715/854; 715/234; 715/846

(57) ABSTRACT

In an embodiment, a modeling environment (ME) may be configured to provide a navigation widget for navigating through a model. The navigation widget may display a first hierpath where the first hierpath is associated with a path to a first portion of the model. The ME may receive input, via the navigation widget, that is associated with a second hierpath, the second hierpath being associated with a path to a second portion of the model. In response to receiving the input, the ME may display a view of the second portion of the graphical model.

### RELATED APPLICATIONS

The present application is a continuation-in-part of U.S. patent application Ser. No. 11/359,342, titled “SYSTEM AND METHOD OF NAVIGATING AND CREATING ELECTRONIC HIERARCHICAL DOCUMENTS”, which was filed on Feb. 22, 2006 and which is a continuation of U.S. patent application Ser. No. 09/858,141, titled “SYSTEM AND METHOD OF NAVIGATING AND CREATING ELECTRONIC HIERARCHICAL DOCUMENTS”, which was filed on May 14, 2001.

In addition, the present application is a continuation-in-part of U.S. patent application Ser. No. 11/820,154, titled “HIERARCHICAL REFERENCES OR LINKS IN MODELING ENVIRONMENTS”, which was filed on Jun. 18, 2007 and which is a continuation of U.S. patent application Ser. No. 10/748,064, titled “HIERARCHICAL REFERENCES OR LINKS IN MODELING ENVIRONMENTS”, which was filed on Dec. 29, 2003.

Moreover, the present application claims the benefit of U.S. Provisional Application No. 61/184,575, titled “MODEL NAVIGATION”, which was filed on Jun. 5, 2009.

The present application claims the benefit of all of the above applications and incorporates the contents of all of the above applications by reference as though fully set forth herein.

### BACKGROUND

Modeling environments may include textual modeling environments and/or graphical modeling environments that may be used to generate, compile, and/or execute one or more models that represent systems. Modeling environments may cater to various aspects of dynamic system simulation, synthesis, analysis, and design. Such modeling environments may allow users to perform numerous types of tasks including, for example, constructing and simulating models.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates an example of a computing device that may be configured to implement one or more embodiments of the invention;

FIG. 2 illustrates an example of a modeling environment (ME) that may be configured to implement one or more embodiments of the invention;

FIGS. 3A-G illustrate examples of navigating through layers in a model using a navigation widget;

FIG. 4 illustrates an example of entering a hierpath in an edit box that is part of a navigation widget in order to navigate through a model;

FIG. 5 illustrates an example of a hierpath that may be used to indicate a level in a model that does not contain non-virtual blocks;

FIG. 6 illustrates an example of a hierpath that indicates a history of navigation through levels in a model;

FIGS. 7A-D illustrate examples of navigating to code views of a model using a navigation widget;

FIGS. 8A-D illustrate an example of a dependency view of a model that may be navigated to using a navigation widget;

FIG. 9 illustrates an example of a hierarchical display of a model that may be displayed using a navigation widget;

FIGS. 10A-C illustrate an example of adding a graphical entity from a first level in a model to a second level in the model using a navigation widget;

FIGS. 11A-D illustrate an example of synchronizing a tree view of a model with a hierpath displayed in a navigation widget;

FIGS. 12A-C illustrate examples of navigating to blocks in a model;

FIG. 13 illustrates a flow chart of example acts that may be used to navigate a model using a navigation widget;

FIG. 14 illustrates a flow chart of example acts that may be used to display a selected view of a model using a navigation widget;

FIG. 15 illustrates a flow chart of example acts that may be used to display a hierpath that represents a dependency between a first element and a second element in a dependency view of a model;

FIG. 16 illustrates a flow chart of example acts that may be used to select an entity in a first portion of a model and add the selected entity to a second portion of the model using a navigation widget;

FIG. 17 illustrates a flow chart of example acts that may be used to synchronize a tree view of a model with a hierpath using a navigation widget; and

FIG. 18 illustrates an example of a distributed environment that may be configured to implement one or more embodiments of the invention.

### DETAILED DESCRIPTION

The following detailed description refers to the accompanying drawings. The same reference numbers in different drawings may identify the same or similar elements. Also, the following detailed description does not limit the invention.

One or more embodiments of the invention may be implemented on one or more computing devices. The one or more computing devices may be a system or part of a system. The one or more computing devices may include a desktop computer, a laptop computer, a client computer, a server computer, a mainframe computer, a personal digital assistant (PDA), a personal navigation device (PND), a web-enabled cellular telephone, a smart phone, a smart sensor/actuator, or some other computing device.

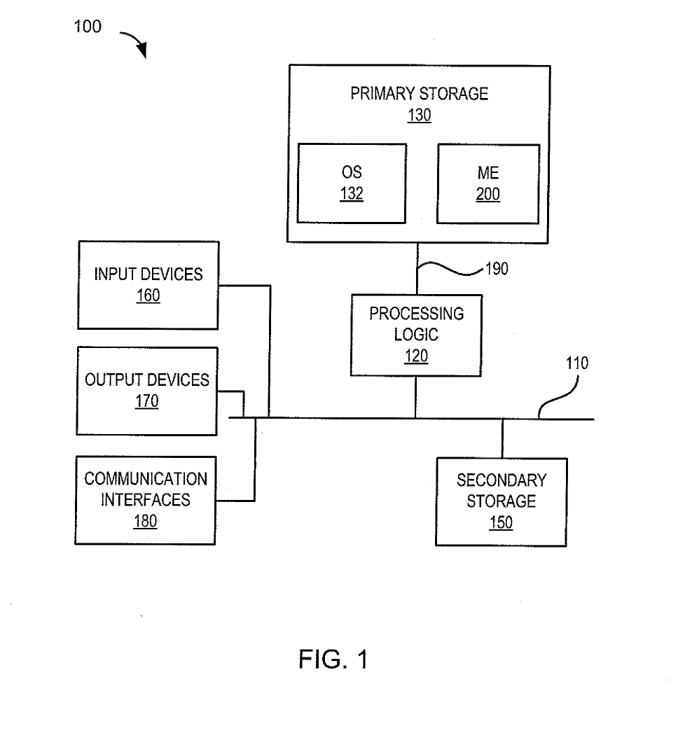

FIG. 1 illustrates an example of a computing device 100 that may be configured to implement one or more embodiments of the invention. Referring to FIG. 1, the computing device 100 may include one or more components, such as, an input-output (I/O) bus 110, processing logic 120, primary storage 130, secondary storage 150, one or more input devices 160, one or more output devices 170, one or more communication interfaces 180, and a memory bus 190. Note that computing device 100 is an example of a computing device that may be configured to implement one or more embodiments of the invention. It should be noted that other computing devices that may be less complicated or more complicated than computing device 100 may be configured to implement one or more embodiments of the invention.

The I/O bus 110 may be an interconnect bus configured to enable communication among various components in the computing device 100, such as processing logic 120, secondary storage 150, input devices 160, output devices 170, and communication interfaces 180. The communication may include, among other things, transferring information (e.g., data and control information) between the components.

The memory bus 190 may be an interconnect bus configured to enable information to be transferred between the processing logic 120 and the primary storage 130. The information may include instructions and/or data that may be executed, manipulated, and/or otherwise processed by processing logic 120. The instructions and/or data may include instructions and/or data that are configured to implement one or more embodiments of the invention.

The processing logic 120 may include logic configured to interpret, execute, and/or otherwise process information contained in, for example, the primary storage 130 and/or secondary storage 150. The information may include instructions and/or data configured to implement one or more embodiments of the invention. The processing logic 120 may include a variety of heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units, multiprocessor systems-on-chip (MPSoCs), or other types of processing logic that may interpret, execute, manipulate, and/or otherwise process the information. The processing logic 120 may include a single core or multiple cores. An example of a processor that may be used to implement processing logic 120 is the Intel® Xeon® processor available from Intel Corporation, Santa Clara, Calif.

The secondary storage 150 may be a computer-readable media that is accessible to the processing logic 120 via I/O bus 110. The secondary storage 150 may be configured to store information for the processing logic 120. The information may be executed, interpreted, manipulated, and/or otherwise processed by the processing logic 120. The secondary storage 150 may include, for example, a storage device, such as a magnetic disk, optical disk, random-access memory (RAM) disk, flash drive, etc. The information may be stored on one or more computer-readable media contained in the storage device. Examples of media that may be contained in the storage device may include magnetic discs, optical discs, and memory devices (e.g., flash memory devices, static RAM (SRAM) devices, dynamic RAM (DRAM) devices, or other memory devices). The information may include data and/or computer-executable instructions that may implement one or more embodiments of the invention.

The input devices 160 may include one or more mechanisms that may provide information that may be input into computing device 100. This information may include, for example, text and/or spatial (e.g., continuous, multi-dimensional) data. The spatial data may include, for example, coordinates of various points in a display that is displayed by an output device 170. The input devices 160 may include switches that may be used to specify various preferences. For example, the input devices 160 may include a computer mouse that contains buttons that enable a user to point, click, drag, and drop items in a display. Movements of the mouse may be echoed on the display by movements of a pointer, cursor, and/or other visual changes. The input devices 160 may include, for example, a keyboard, computer mouse, microphone, camera, trackball, gyroscopic device (e.g., gyroscope), mini-mouse, touch pad, stylus, graphics tablet, touch screen, joystick (isotonic or isometric), pointing stick, accelerometer, palm mouse, foot mouse, puck, eyeball controlled device, finger mouse, light pen, light gun, eye tracking device, steering wheel, yoke, jog dial, space ball, directional pad, dance pad, soap mouse, haptic device, tactile device, neural device, multipoint input device, discrete pointing device, or other input device.

The output devices 170 may include one or more mechanisms that may output information from the computing device 100. The output devices 170 may include logic that may be directed by, for example, the processing logic 120, to output the information from the computing device 100. The information may be presented in the form of a display that may be displayed by the output devices 170. The information may include, for example, graphical user interface (GUI) elements (e.g., windows, widgets, etc.), a graphical block diagram of a model, text, or other information. The output devices 170 may include, for example, a cathode ray tube (CRT), plasma display device, light-emitting diode (LED) display device, liquid crystal display (LCD) device, vacuum florescent display (VFD) device, surface-conduction electron-emitter display (SED) device, field emission display (FED) device, haptic device, tactile device, printer, speaker, video projector, or other output device.

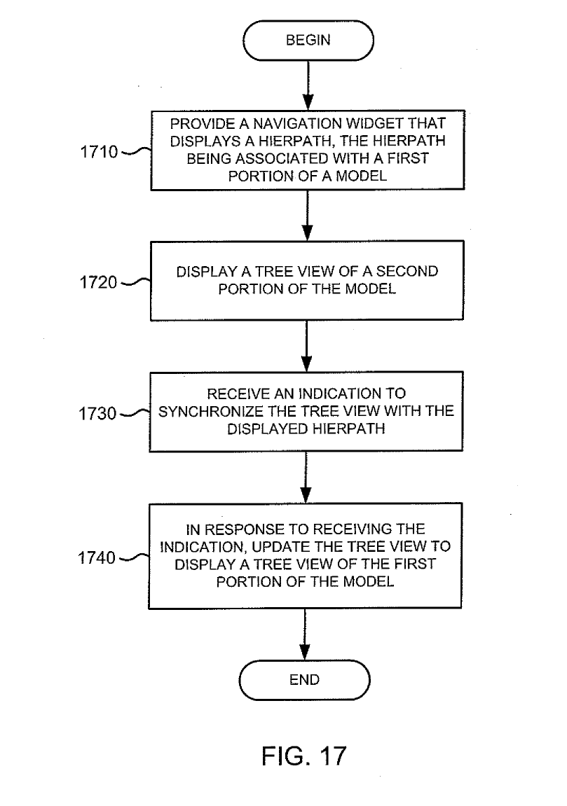

The communication interfaces 180 may include logic configured to interface the computing device 100 with, for example, a communication network and enable the computing device 100 to communicate with entities connected to the network. An example of a network that may be used with computing device 100 will be described further below with respect to FIG. 17.

The communication interfaces 180 may include a transceiver-like mechanism that enables the computing device 100 to communicate with the entities connected to the network. The communication interfaces 180 may be implemented as a built-in network adapter, network interface card (NIC), Personal Computer Memory Card International Association (PCMCIA) network card, card bus network adapter, wireless network adapter, Universal Serial Bus (USB) network adapter, modem or other device suitable for interfacing the computing device 100 to the network.

The primary storage 130 is accessible to the processing logic 120 via bus 190. The primary storage 130 may include one or more computer-readable media configured to store information for processing logic 120. The information may include computer-executable instructions and/or data that are configured to implement operating system (OS) 132 and modeling environment (ME) 200. The instructions may be executed, interpreted, and/or otherwise processed by processing logic 120.

The primary storage 130 may include a RAM that may include RAM devices configured to store information (e.g., data, executable instructions). The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

OS 132 may be a conventional operating system that may be configured to implement various conventional operating system functions. These functions may include, for example, scheduling one or more portions of ME 200 to run on the processing logic 120, managing the primary storage 130, controlling access to various components associated with the computing device 100 (e.g., input devices 160, output devices 170, network interfaces 180, secondary storage 150), and controlling access to data received and/or transmitted by these components. Examples of operating systems that may be used to implement OS 132 may include, but are not limited to, the Linux operating system, Microsoft Windows operating system, the Symbian operating system, Mac OS, and the Android operating system. A version of the Linux operating system that may be used is Red Hat Linux available from Red Hat Corporation, Raleigh, N.C. Versions of the Microsoft Windows operating system that may be used include the Microsoft Windows Vista and Microsoft Windows XP operating systems available from Microsoft Inc., Redmond, Wash. The Mac OS is available from Apple, Inc., Cupertino, Calif.

ME 200 may be a modeling environment (e.g., a graphical modeling environment, textual modeling environment) that may be configured to implement one or more embodiments of the invention. Some or all of ME 200 may operate under the control of OS 132. Moreover, ME 200 and/or OS 132 may operate under control of virtualization software, which may or may not be hardware assisted. Examples of virtualization software include, but are not limited to, Bochs, QEMU, VMware, Xen, and OpenVZ.

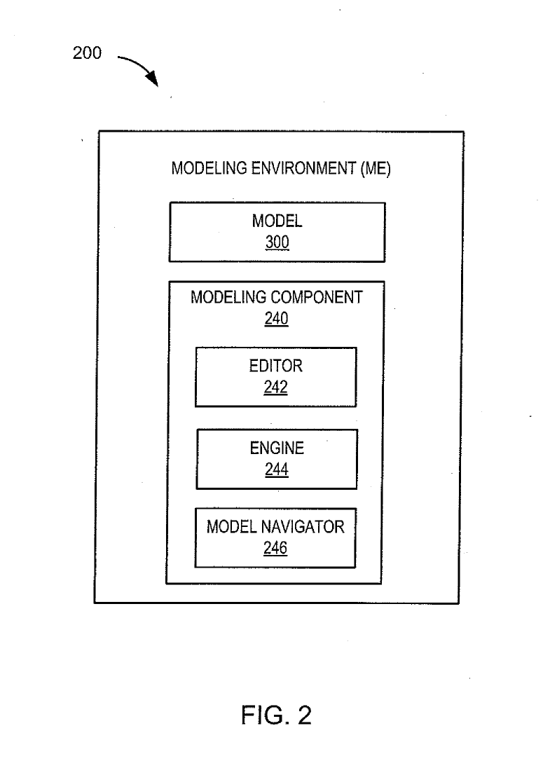

FIG. 2 illustrates an example implementation of ME 200. Referring to FIG. 2, the ME 200 may include various components including model 300 and modeling component 240. ME 200 may be configured to, among other things, construct, compile, execute, and interpret a model, such as model 300. In addition, as will be described further below, ME 200 may provide a navigation widget that may be used, among other things, to navigate to and display different portions of the model.

The ME 200 may include hardware-based and/or software-based logic configured to provide a computing environment that may allow, for example, a user to perform tasks related to disciplines, such as, but not limited to, mathematics, science, engineering, medicine, business, biology, finance, and so on. The ME 200 may include a dynamically-typed programming language (e.g., the MATLAB® M language) that can be used to express problems and/or solutions in mathematical notations.

For example, the ME 200 may use an array as a basic element, where the array may not require dimensioning. The array may be used to support array-based programming where an operation can apply to an entire set of values included in the array. Array-based programming may allow array-based operations to be treated as a high-level programming technique that may allow, for example, operations to be performed on whole aggregations of data without having to resort to explicit loops of individual non-array operations.

In addition, the ME 200 may be configured to perform matrix and/or vector formulations that may be used for data analysis, data visualization, application development, simulation, modeling, and/or algorithm development. These matrix and/or vector formulations may be used in many areas, such as statistics, image processing, signal processing, control design, life sciences modeling, discrete event analysis and/or design, state-based analysis and/or design, or other areas.

The ME 200 may further provide mathematical functions and/or graphical tools or blocks (e.g., for creating plots, surfaces, images, volumetric representations, or other representations). The ME 200 may provide these functions and/or tools using toolboxes (e.g., toolboxes for signal processing, image processing, data plotting, and/or parallel processing). In addition, the ME 200 may provide these functions as block sets. The ME 200 may also provide these functions in other ways, such as via a library, local or remote database, or other ways.

The ME 200 may include a graphical-based environment. The ME 200 may include provisions for creating, compiling, executing, and/or interpreting models, such as model 300. The models may be graphical and/or textual and may be executable (e.g., executable block diagram models).

Examples of MEs that may be modified to incorporate one or more embodiments of the invention include, but are not limited to, MATLAB®, Simulink®, Stateflow®, and SimEvents®, which are available from The MathWorks, Inc., Natick, Mass.; Unified Modeling Language (UML); profiles associated with UML (e.g., Modeling Analysis and Real-Time Embedded Systems (MARTE), Systems Modeling Language (SysML), Avionics Architecture Description Language (AADL)); GNU Octave from the GNU Project; MATRIXx and LabView® from National Instruments; Mathematica from Wolfram Research, Inc.; Mathcad from Mathsoft Engineering & Education Inc.; Maple from Maplesoft; Extend from Imagine That, Inc.; Scilab and Scicos from The French Institution for Research in Computer Science and Control (INRIA); Modelica or Dymola from Dynasim AB; VisSim from Visual Solutions; SoftWIRE from Measurement Computing Corporation; WiT from DALSA Coreco; VEE Pro and SystemVue from Agilent Technologies, Inc.; Vision Program Manager from PPT Vision, Inc.; Khoros from Khoral Research, Inc.; VisiQuest from Pegasus Imaging Corporation; Gedae from Gedae, Inc.; Virtuoso from Cadence Design Systems, Inc.; Rational Rose, Rhapsody and Tau from International Business Machines (IBM), Inc.; SCADE from Esterel Technologies; the Eclipse development platform from the Eclipse Foundation; MagicDraw from No Magic, Inc.; and Ptolemy from the University of California at Berkeley.

Model 300 may be, for example, a time-based graphical block diagram model, a state transition diagram, a discrete event model, an activity diagram, a UML diagram, a sequence diagram, a data flow model, or some other type of model or diagram. Model 300 may be configured to represent a system. Model 300 may be graphical, textual, or some combination of graphical and textual. The model 300 may be array based. The system represented by model 300 may be dynamic, linear, non-linear, or some other type of system.

A dynamic system (either natural or man-made) may be a system whose response at any given time may be a function of its input stimuli, its current state, and a current time. Such systems may range from simple to highly complex systems. Natural dynamic systems may include, for example, a falling body, the rotation of the earth, bio-mechanical systems (e.g., muscles, joints, etc.), bio-chemical systems (e.g., gene expression, protein pathways), weather, and climate pattern systems. Examples of man-made or engineered dynamic systems may include, for example, a bouncing ball, a spring with a mass tied on an end, automobiles, airplanes, control systems in appliances, communication networks, audio signal processing, nuclear reactors, and a stock market.

The system represented by model 300 may have various execution semantics that may be represented in model 300 as a collection of modeling elements, often referred to as blocks. A block may generally refer to a portion of functionality that may be used in the model 300. The block may be graphically represented, however, it can be appreciated that the block does not necessarily need to be represented graphically. For example, the block may be represented textually or stored in some form of internal representation. Also, a particular visual depiction used to represent the block, for example in a graphical block diagram, may be generally an arbitrary design choice.

A block may be hierarchical in that the block itself may include one or more blocks that make up the block. A block that includes one or more blocks (sub-blocks) may be referred to as a subsystem block. A subsystem block may be configured to represent a subsystem of the overall system represented by the model.

One or more blocks in a block diagram of model 300 may be virtual or non-virtual. A non-virtual block may influence equations used to model a dynamic system. Virtual blocks, on the other hand, typically do not affect the equations used to model the dynamic system. In other words, virtual blocks often wield no semantic influence on the model from a mathematical perspective. Rather, virtual blocks are often used to help improve the readability and modularity of a block diagram of a model. Examples of virtual blocks may include Simulink® virtual sub-systems, input port (inport) blocks, output port (outport) blocks, bus creator blocks, “from” blocks, and “goto” blocks.

A signal may represent an input and/or an output of an elemental dynamic system represented by a block. Signals may correspond to time-varying quantities represented by a line connection to or from the block and may have values at various time instants during a simulation of the model 300. A source block of a signal may write to the signal at a given time instant when the source block's system equations are solved. A destination block of the signal may read the signal when the destination block's system equations are being solved.

Model 300 may include time-based relationships between signals and various state variables representative of the system modeled by model 300. A solution (e.g., computation of system response) of the model 300 may be obtained by evaluating these relationships over time, where the time may start at a predetermined “start time” and end at a predetermined “stop time” or the evaluation may proceed indefinitely potentially being interrupted or terminated by, for example, user interaction. For a class of systems, an evaluation of the relationships may be referred to as a time-step of execution of model 300. Signals may represent quantities that change over time, and these quantities may be defined for various points in time of the block diagram's evaluations. Relationships between signals and state variables may be defined by sets of equations associated with blocks that make up model 300. These equations may define a relationship between the input signals, output signals, state, and time. The blocks may also be associated with parameters, which may be coefficients of the equations.

It should be noted that model 300 may not only be used to represent time-based dynamic systems but also may be used for other models of computation. For example, model 300 may be used to represent a flowchart that may be used to capture a process flow. Model 300 may also be used to describe a programming paradigm (e.g., a data flow paradigm) where an availability of data (often thought of as tokens) may be used to initiate an execution of blocks. Here, a block may represent an operation and a line may represent an execution dependency describing a direction of data flowing between blocks.

Modeling component 240 may contain computer-executable instructions and data that are configured to perform various tasks including (1) constructing model 300, for example, through a GUI; (2) allowing an augmentation of a pre-defined set of blocks with custom user-specified blocks that may be included in model 300; (3) using model 300 to compute and trace a temporal evolution of outputs associated with a system represented by the model 300; and (4) automatically producing, for example, deployable software systems, and descriptions of hardware systems that mimic a behavior of either the entire model 300 or portions of model 300. Blocks included in model 300 may be represented in a graphical representation (e.g., a block diagram) of the model 300 that may be presented by the ME 200 to, for example, a user.

The modeling component 240 may include an editor 242, an execution engine 244, and a model navigator 246. The editor 242 may be configured to allow, for example, a user, to specify, edit, annotate, save, publish, and print a block diagram of model 300 including one or more blocks.

The execution engine 244 may be configured to enable a computation and/or tracing of a dynamic system's outputs from model 300. The execution engine 244 may carry out the task of compiling and linking the block diagram to produce an “in-memory executable” version of model 300 that may be used for simulating, verifying, generating code, trimming, or linearizing the model 300.

Compiling may include checking an integrity and validity of block interconnections in the block diagram. At this stage, the execution engine 244 may also sort the blocks in the block diagram into hierarchical lists that may be used when creating block execution lists. Linking may include using a result of the compiled stage to allocate memory needed for an execution of the various components of the model 300. Linking may also include producing block execution lists that are used, for example, by a simulation or linearization of model 300. Included within the link stage may be an initialization of model 300 which may include an evaluating of “setup” methods (e.g. block start, initialize, enable, and constant output methods). The block execution lists may be generated because the simulation and/or linearization of the model 300 may execute block methods by type (not by block) when they have a sample hit.

The model navigator 246 may be used to navigate through the model 300. As will be described further below, the model navigator 246 may incorporate an interface (e.g., a GUI) that may be used by a user to, among other things, navigate to and view various elements (e.g., levels, blocks, views) associated with the model 300.

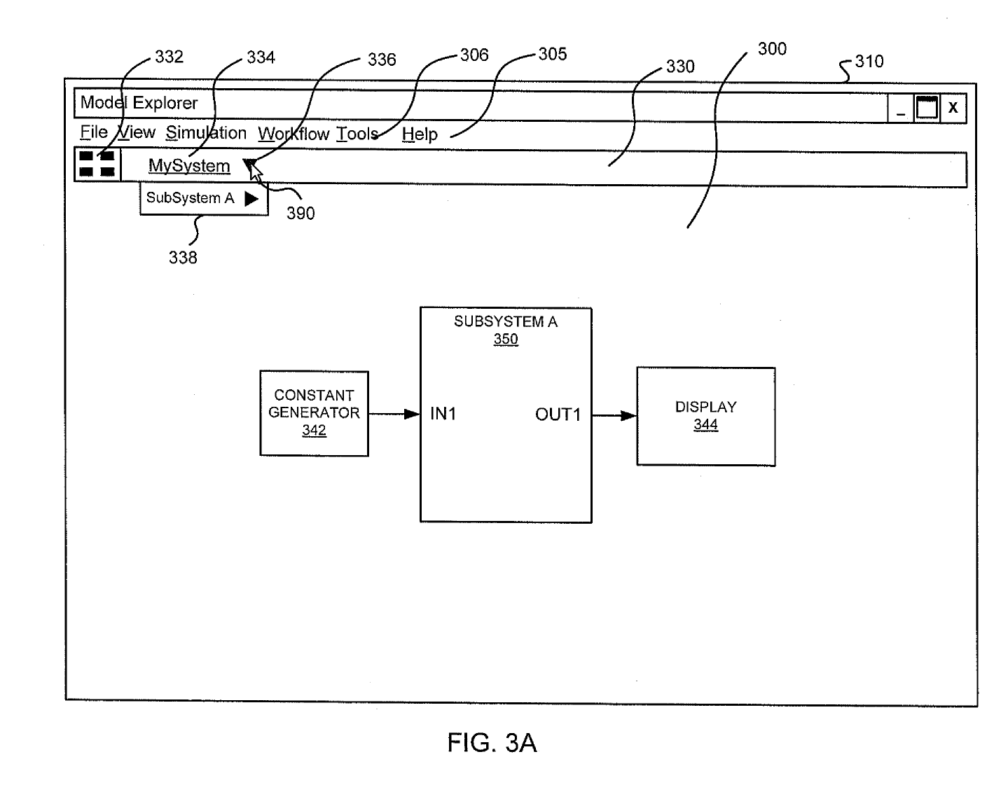

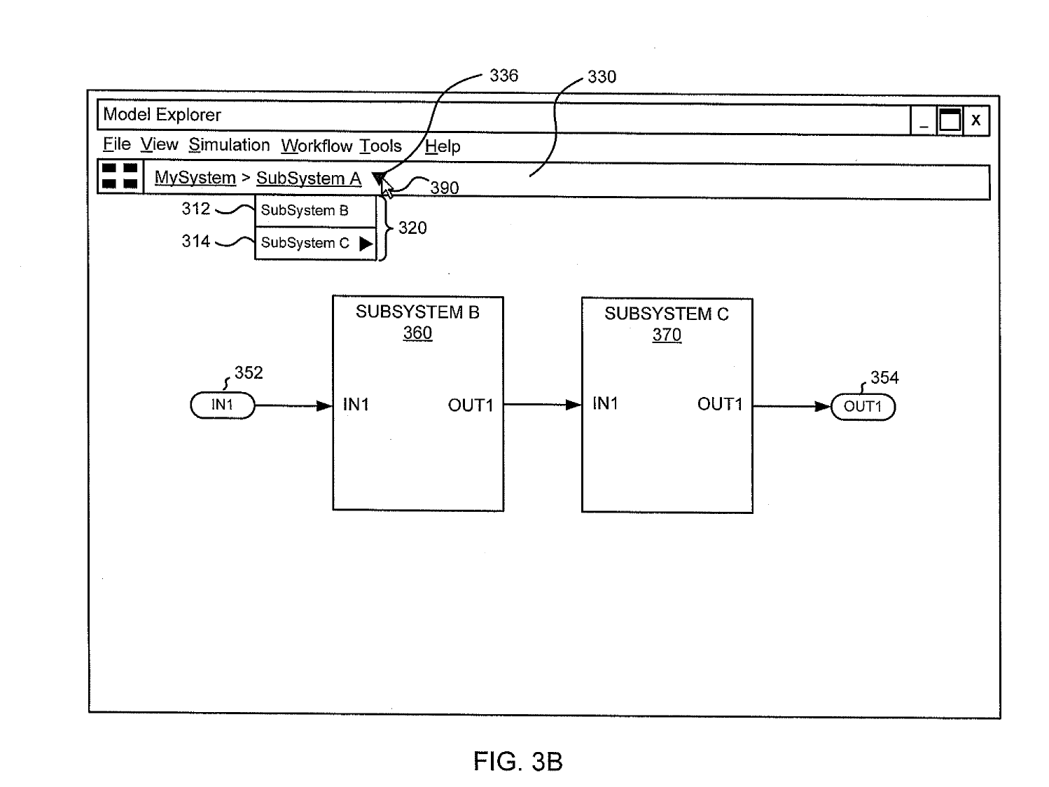

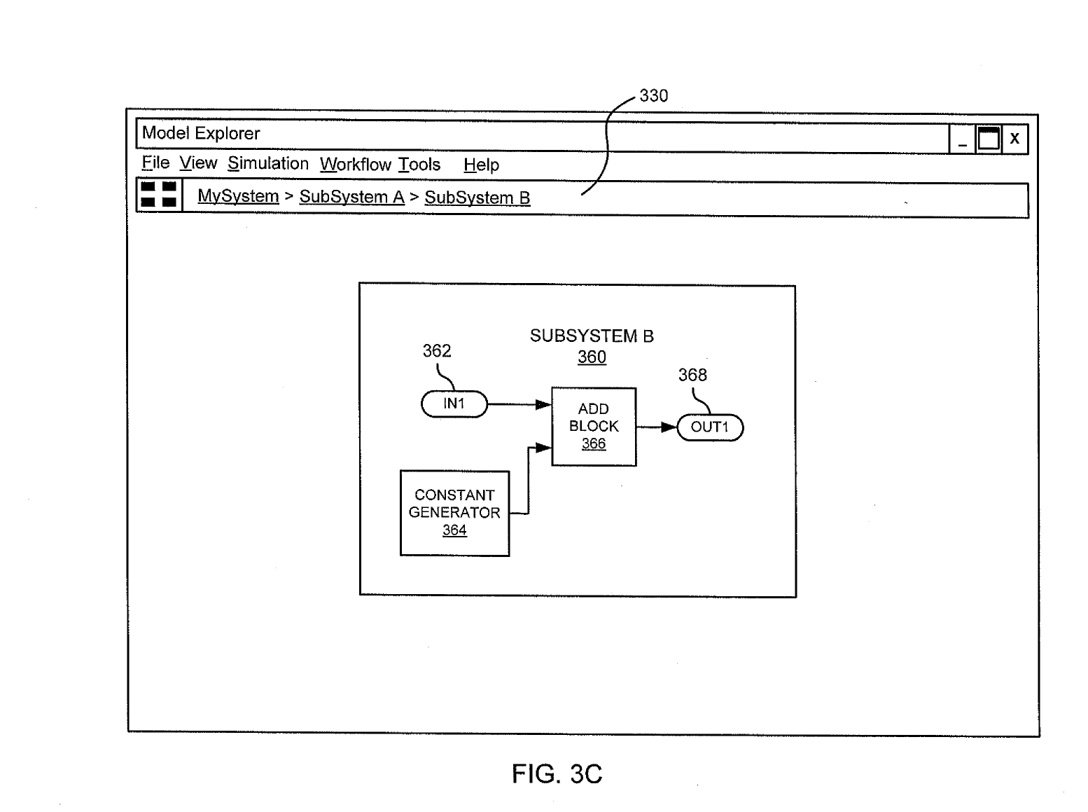

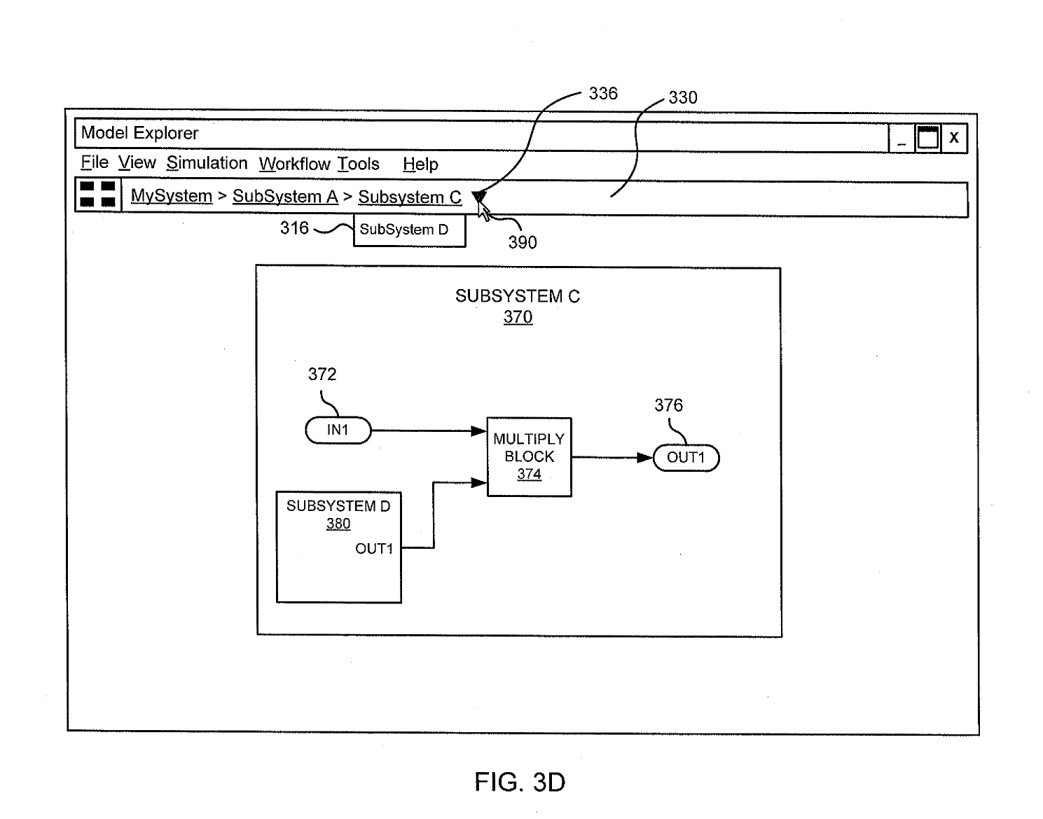

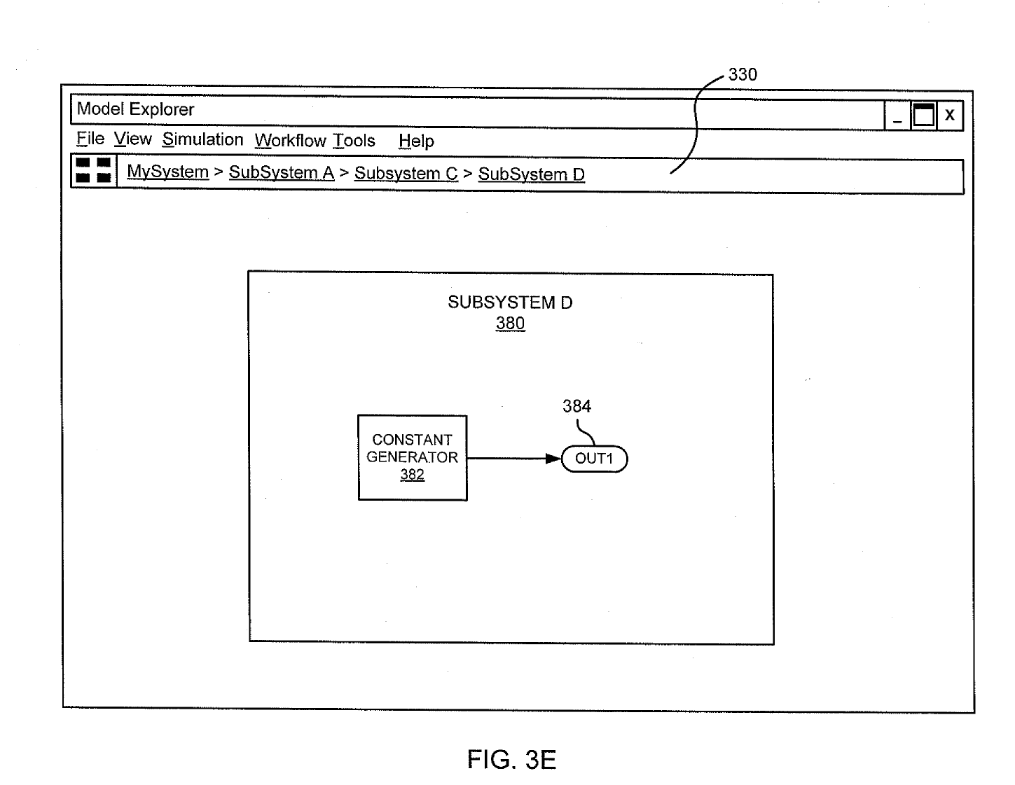

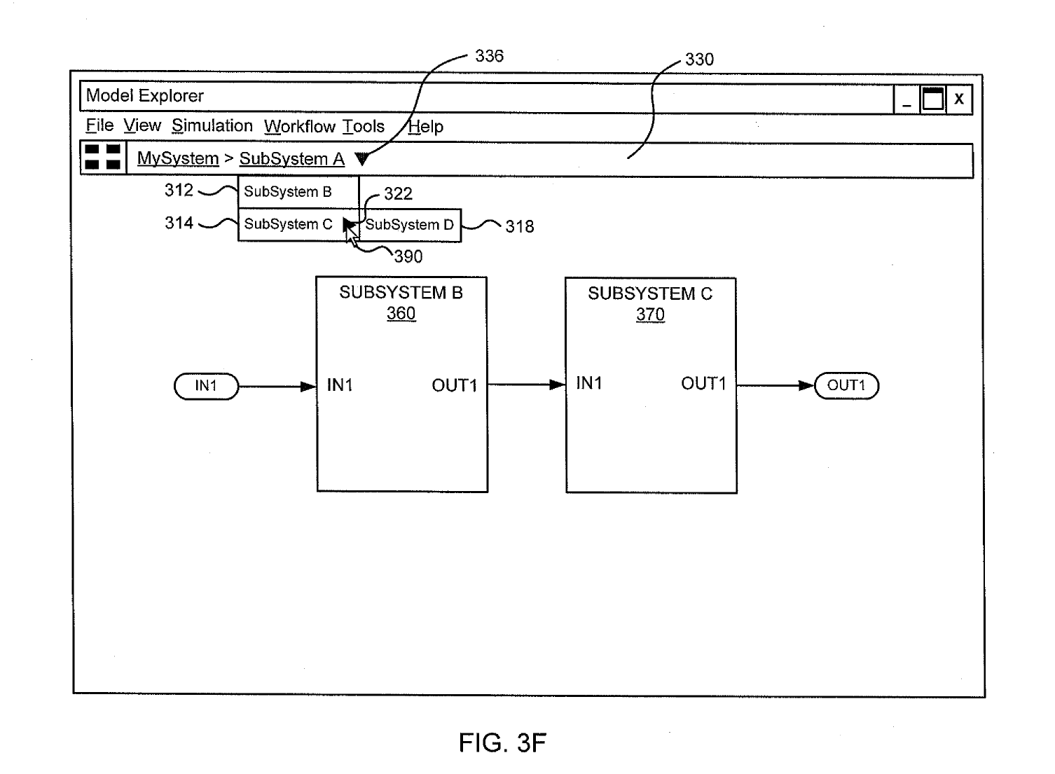

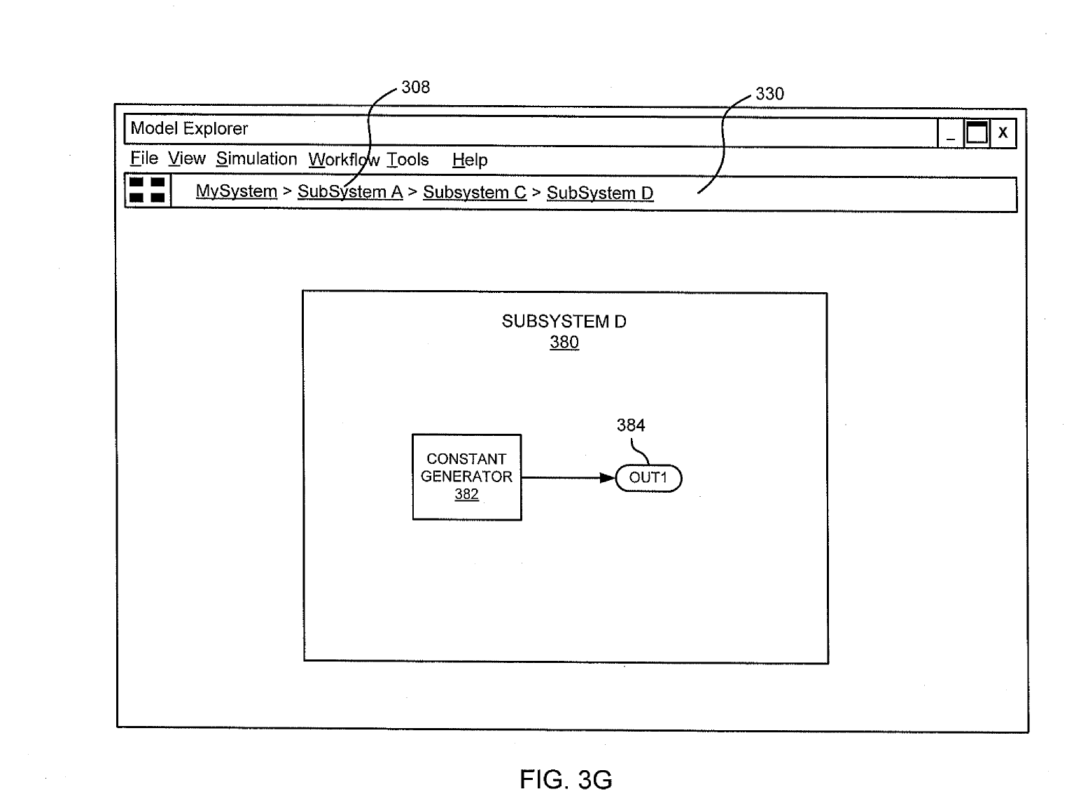

FIG. 3A illustrates a block diagram of an embodiment of model 300. Referring to FIG. 3A, the block diagram is presented in a graphical window 310 that may be generated and displayed by the model navigator 246. As seen in the block diagram, model 300 may contain a constant generator block 342, subsystem A block 350, and display block 344. The constant generator block 342 and display block 344 are non-virtual blocks. The subsystem A block 350 is a virtual block. The constant generator 342 is configured to generate a constant value that is output as a signal. The signal is input into subsystem A 350 at an input port (inport) named “IN1”. Subsystem A 350 also includes an output port (outport) named “OUT1”, which outputs a signal that is input into the display block 344. Details of subsystem A 350 will be discussed further below. The display block 344 is configured to display the signal that is output from subsystem A's outport “OUT1”. The signal may be displayed to a user in a separate window (not shown).

Graphical window 310 may provide an interface through which commands relating to model 300 may be entered. For example, graphical window 310 may include a menu bar 305 that may allow a user to select various menus. The menus may contain menu items that when selected perform various commands. For example, menu bar 305 contains a “tools” menu 306 that may include a menu item (not shown) that when selected may display parameter information associated with a block in model 300. It should be noted that other techniques may be used to enter commands relating to model 300. For example, a command line interface may be provided that enables commands relating to the model 300 to be entered.

Window 310 also includes a navigation widget 330 that may be used to, among other things, navigate to and display different elements (e.g., levels, blocks, views) associated with model 300. The navigation widget 330 may contain various entities which may include a hierarchical display button 332, a hierpath widget 334, and a drop-down menu button 336. Note that navigation widget 330 may contain more or fewer entities than illustrated in FIG. 3A. Also note that the navigation widget 330 may be located in a location in a window other than the location illustrated in window 310.

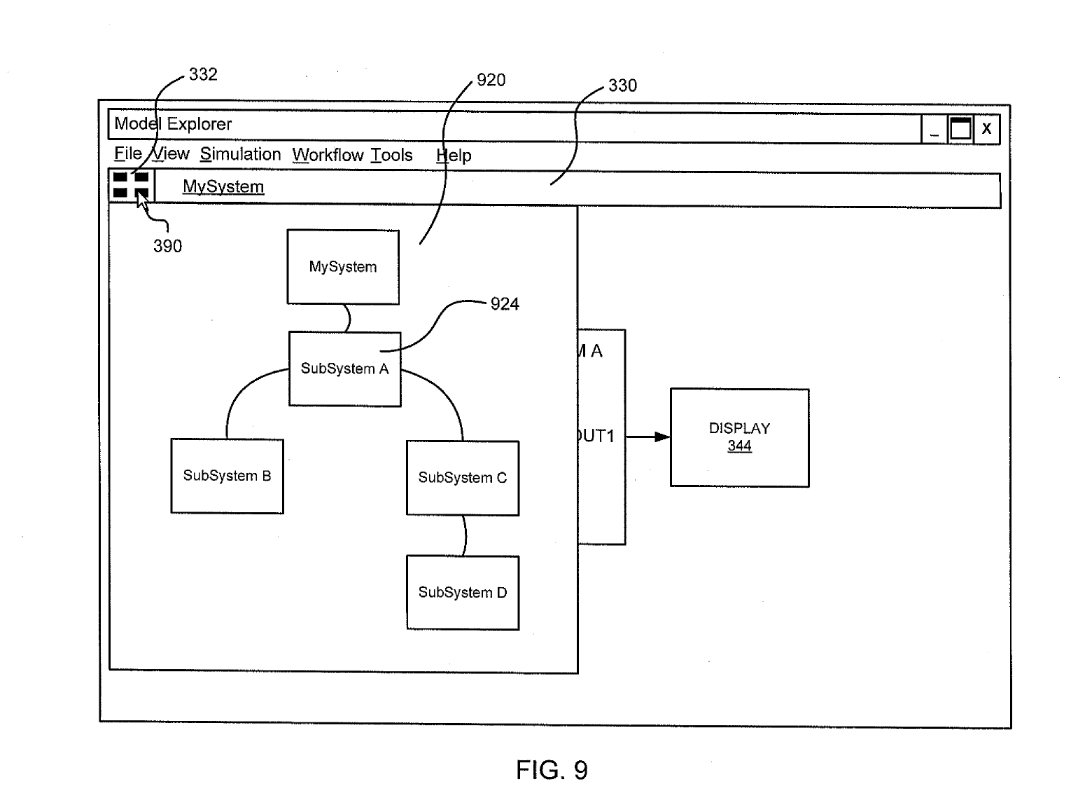

Hierarchical display button 332 may be used to display a hierarchical display of model 300. More details of hierarchical display button 332 will be described further below with respect to FIG. 9.

The hierpath widget 334 displays a hierpath for model 300. A hierpath for a model may be used to indicate a path to an entity in the model. The entity may be, for example, a level in a hierarchy of the model, a block in the model, etc. The hierpath may contain elements (e.g., text, icons, active links) that may be associated with entities in the model that make up the path. Moreover, the elements may be active. An element that is active element may be used to actively interact with a model. For example, as will be described further below, an element that is active may be used to navigate through multiple levels in a model, copy entities (e.g., blocks) between levels in a model, navigate to a specific view of the model, expand a tree view of the model, etc. A hierpath is flat in that it may be used to perform these activities without requiring, e.g., expansion of nodes in a tree that may represent a path to an entity.

For example, as will be described further below, model 300 may contain various hierarchical levels. A topmost level may be represented by the text “MySystem”. A subsystem at a level directly below the topmost level may be represented by the text “SubSystem A”. A hierpath to the subsystem may be specified as “MySystem>Subsystem A” where “MySystem” is an element in the hierpath that represents the topmost level and “Subsystem A” is an element in the hierpath that represents the subsystem directly below the topmost level and where the “>” character may be used to delimit elements in the hierpath.

It should be noted that other ways of expressing a hierpath may be used. For example, other characters or text may be used to delimit elements indicated in the hierpath path. Likewise, for example, icons may be used to represent elements or delimiters in a hierpath.

The drop-down menu button 336 may be used to display a drop-down menu of possible hierpaths to navigate to in the model from the current hierpath displayed in navigation widget 330. Selecting the drop-down menu button 336, for example by positioning a pointing device's cursor 390 over the button 336, may cause the drop-down menu to be displayed. The drop-down menu may contain one or more items that enable a user to navigate to a different level in the model's hierarchy. Navigating to a level may cause a portion of the model associated with that level to be displayed. In this example, the drop-down menu contains one item 338, which may be used to navigate to subsystem A 350, which is one level below the topmost level named “MySystem”.

It should be noted that item 338 may be displayed in other ways. For example, a user may use the pointing device to select a level indicated in the hierpath, the ME 200 may receive the selection and, in response to the selection, display item 338. Specifically, in FIG. 3A, a user may use the pointing device to select the text “MySystem” in the displayed hierpath. The text may be selected by hovering the cursor 390 over the text, hovering the cursor 390 then selecting a button on the pointing device, etc. Item 338 may be displayed in response to selecting the text “MySystem”.

Selecting menu item 338 may cause the model navigator 246 to navigate to subsystem A 350. Moreover, the contents of subsystem A 350 may be displayed in, for example, a block diagram view, as depicted in FIG. 3B. FIG. 3B illustrates a block diagram view of subsystem A 350. Referring to FIG. 3B, subsystem A 350 contains an inport block 352, a subsystem B block 360, a subsystem C block 370, and an outport block 354. Note that all of the blocks in the block diagram of subsystem A 350 depicted in FIG. 3B are virtual blocks.

After a level has been navigated to, ME 200 may allow a user to make changes to that portion of the model that is present at that level. Thus, for instance, in FIG. 3B, a user may modify subsystem A 350 to, for example, add or remove blocks, change parameters associated with the blocks, connect the blocks differently, and so on.

Note that the hierpath in the navigation widget 330 has been updated to display the hierpath to subsystem A 350. Selecting the drop-down menu button 336 next to the hierpath may cause a drop-down menu 320 to be displayed. The drop-down menu 320 contains two menu items, a “SubSystem B” menu item 312 and a “SubSystem C” menu item 314. Selecting the SubSystem B menu 312 item may cause the model navigator 246 to navigate to subsystem B 360. Likewise, selecting the SubSystem C menu item 314 may cause the model navigator 246 to navigate to subsystem C 370.

Suppose a user selects the SubSystem B 312 menu item. Referring to FIG. 3C, model navigator 246 may navigate to subsystem B 360 and may display a block diagram view of subsystem B 360. As seen in the block diagram, subsystem B 360 includes an inport block 362, a constant generator block 364, an add block 366, and an outport block 368. The inport 362 and outport 368 blocks are virtual blocks. The constant generator block 364 and add block 366 are non-virtual blocks. Operationally, the constant generator block 364 generates a signal that represents a constant value. Add block 366 adds this signal to a signal that is input into the subsystem 360 at inport block 362. A result of the add operation is output as a signal at outport block 368.

Referring back to FIG. 3B, suppose that instead of selecting the SubSystem B menu item 312, the user selects the SubSystem C menu item 314. FIG. 3D illustrates a block diagram view of subsystem C 370 that may be displayed in response to selecting menu item 314. Referring to FIG. 3D, subsystem C 370 includes an inport block 372, a subsystem D block 380, a multiply block 374, and an outport block 376. Subsystem D 380 is a subsystem that provides a first signal to the multiply block 374. In addition, a second signal, that is input into subsystem C 370 via inport 372, is supplied to the multiply block 374. The multiply block 374 is configured to multiply the first signal by the second signal to produce a result. The result may be output as a signal from subsystem C 380 at outport 376. Note that blocks 372, 380, and 376 are virtual blocks and block 374 is a non-virtual block.

In FIG. 3D, selecting drop-down menu button 336 causes a drop-down menu to be displayed that contains menu item 316. Menu item 316 may be used to navigate to subsystem D 380. Specifically, in response to a selection of menu item 316, the model navigator 246 may navigate to subsystem D 380 in the model 300. In addition, model navigator 246 may display a block diagram view of subsystem D 380, as depicted in FIG. 3E.

Referring now to FIG. 3E, subsystem D 380 includes a constant generator block 382 and an outport block 384. The constant generator 382 generates a signal that represents a constant value. Outport 384 is configured to output the generated signal from subsystem D 380.

The navigation widget 330 may used to navigate through multiple levels in the model. FIGS. 3F and 3G illustrate examples of navigating through multiple levels in model 300.

Referring to FIG. 3F, suppose, for example, that the model navigator 246 has navigated to subsystem A 350 and that a user wishes to navigate from this subsystem 350 directly to subsystem D 380. The user may select drop-down menu button 336 to display a drop-down menu that includes menu items SubSystem B 312 and SubSystem C 314. The user may then select drop-down menu button 322 to display a sub-menu that includes a SubSystem D menu item 318. The user may select menu item 318 and in response to receiving the selection, the model navigator 246 may navigate to subsystem D 380 directly from subsystem A 350. In addition, the model navigator 246 may display a view of subsystem D 380, as illustrated in FIG. 3E.

The hierpath may include one or more active links, such as hyperlinks, that may represent one or more entities (e.g., level, block) in the path represented by the hierpath. An active link may be used to navigate to an entity in the model by selecting the active link associated with the entity.

For example, referring to FIG. 3G, suppose that the model navigator 246 has navigated to subsystem D 380 and has displayed a block diagram of subsystem D 380, as illustrated in FIG. 3G. Now suppose that a user wishes to navigate from subsystem D 380 to subsystem A 350 which is two levels above subsystem D 380. The user may select (e.g., click on, hover a cursor over, etc.) active link 308 in the hierpath to indicate that the user wishes to navigate to subsystem A 350. Selecting this active link 308 may cause the model navigator 246 to navigate to subsystem A 350. In addition, the model navigator 246 may display a block diagram of subsystem A 350, such as illustrated in FIG. 3B.

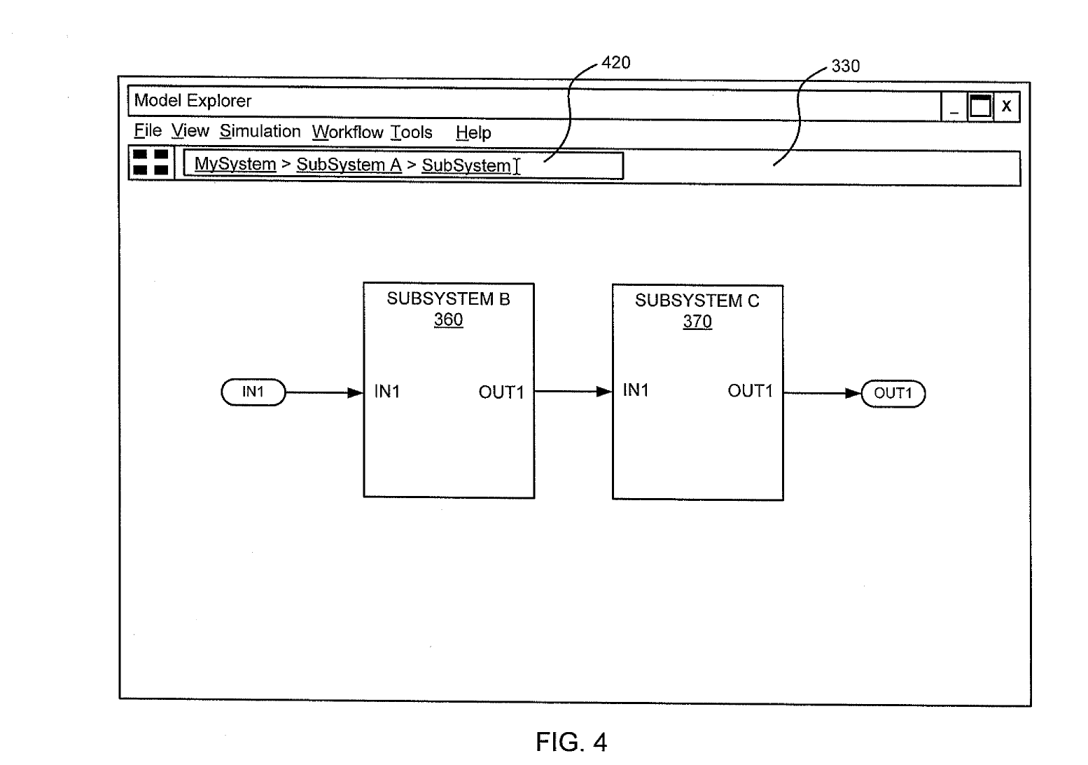

FIG. 4 illustrates an example of textually specifying a hierpath of a level to be navigated to in model 300. Referring to FIG. 4, the navigation widget 330 may include an edit box 420 that may be used to textually specify all or part of the hierpath. Moreover, the edit box 420 may be used to enter regular expressions that may be evaluated to identify all or part of the hierpath.

For example, suppose that the model navigator 246 has navigated to subsystem A 350 and has displayed a block diagram view of subsystem A 350, as illustrated in FIG. 4. Now suppose that a user wishes to navigate from subsystem A 350 to subsystem D 390. The user may provide an indication to the model navigator 246 to cause the edit box 420 to be displayed. This indication may include, for example, positioning a cursor associated with a pointing device to the right of the displayed hierpath and clicking a button on the pointing device, specifying a command, or some other indication. In response to receiving the indication, the model navigator 246 may display edit box 420. The user may then use the edit box 420 to specify the hierpath of subsystem D 390.

Note that the navigation widget 330 may be configured to provide automatic completion of information entered in the edit box 420. For example, the user may type the character “>” in the edit box 420 after the text “SubSystem A” and the model navigator 246 may respond by adding the text “SubSystem” to the edit box 420. The user may then specify “C” for subsystem C 370 in the edit box 420. In response, “MySystem>SubSystem A>SubSystem C” may be displayed in the edit box 420. The user may then enter the character “>” and in response “MySystem>SubSystem A>SubSystem C>SubSystem D” may be displayed in the edit box 420. Alternatively, the user may enter a key sequence that is specially defined to provide a list of possible completions. For example, the character “?” may be defined to provide a list of possible completions. The user may enter this character into the text box and the navigation widget 330 may respond with a list of possible completions. The user may then select a completion from the list. Note that a list of potential completions may also be displayed based on other information entered in the edit box 420 by the user. For example, part of a hierpath entered into the edit box 420 may be matched against all possible completions to produce a list of possible completions for the hierpath. The list may be displayed and the user may select a completion from the list.

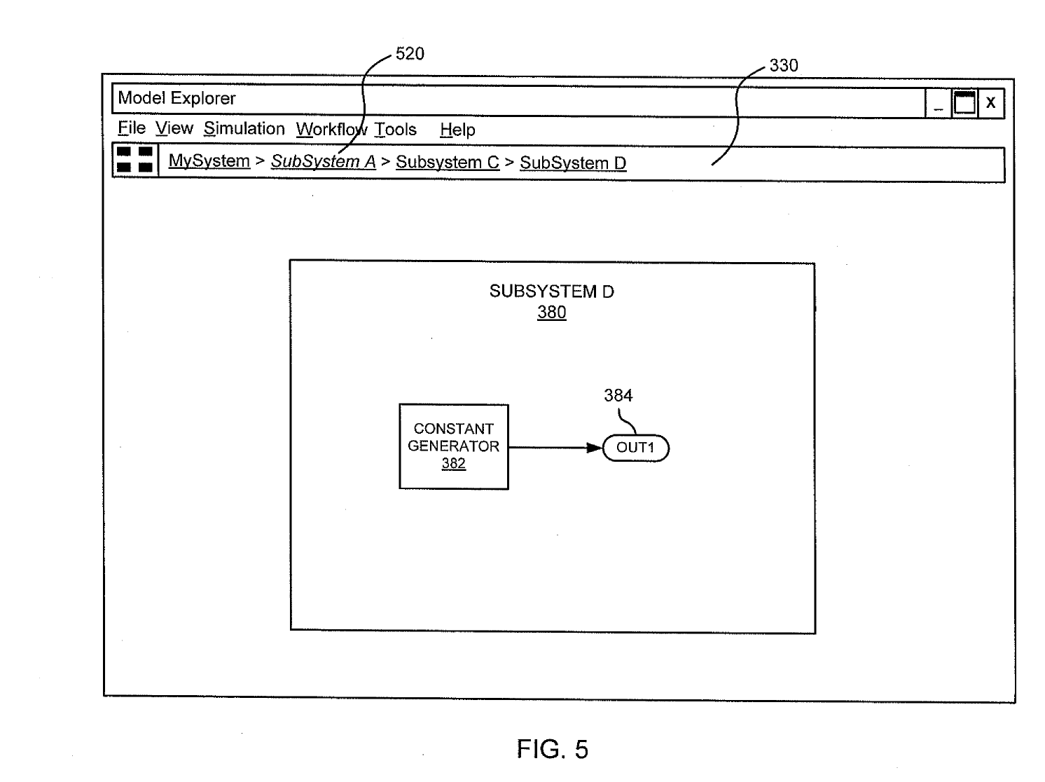

Conditions being satisfied or not being satisfied may be indicated in the displayed hierpath. For example, levels in a model may contain strictly blocks of a certain type may be indicated in the hierpath. For example, as noted above, the blocks at in subsystem A 350 are all virtual blocks. Referring to FIG. 5, a block diagram of subsystem D 380 is displayed along with the hierpath to subsystem D 380. Note that the text “SubSystem A” in the displayed hierpath is presented differently (i.e., italicized) than other text associated with other levels in the hierpath. This difference may be used to indicate a condition where the blocks at that level are all blocks of a certain type (e.g., they are all virtual blocks). Note that other conditions being satisfied or not being satisfied may be indicated in a hierpath and other ways of indicating these conditions may be used. These conditions may include, for example, whether a particular level contains a mix of block types, a particular level does not contain a particular type of block, or some other condition. A condition being satisfied or not being satisfied may be indicated in the hierpath using highlighting, bolding, flashing, underlining, inverting, coloring (e.g., graying-out), collapsing the hierpath, not displaying elements in the hierpath, or some other indication.

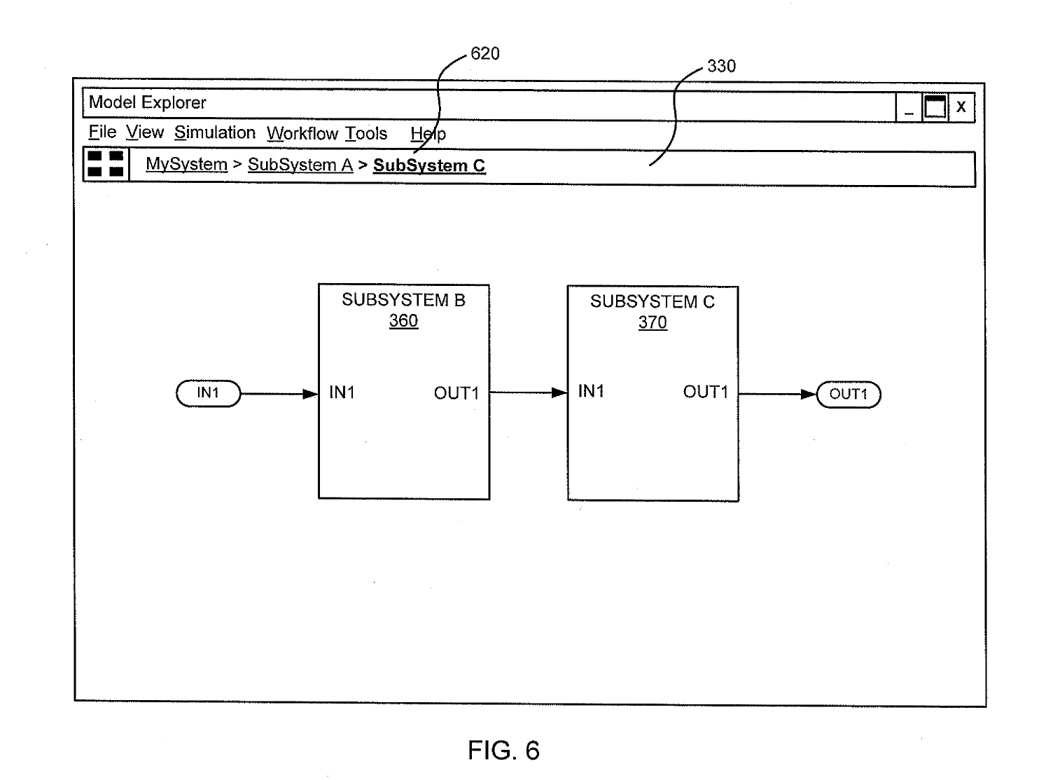

A history of levels that are navigated to in a model may be indicated in a displayed hierpath. For example, referring to FIG. 6, suppose that a user has navigated to subsystem C 370 then navigated to subsystem A 350. A history of this navigation may be shown in the hierpath. FIG. 6 illustrates this history. Referring to FIG. 6, the text “SubSystem C” 620 in the hierpath is displayed differently than the text “MySystem>SubSystem A” to indicate that “SubSystem C” is part of a history of navigating and is not part of the hierpath for the portion of the model being displayed in FIG. 6. In this example, the text “SubSystem C” is displayed differently by bolding the text. Note that other ways of indicating history may be used. For example, history may be indicated in the hierpath by italicizing, flashing, underlining, inverting, coloring (e.g., graying-out), modifying a background of the displayed hierpath, or some other indication. In addition, history may be presented in ways other than altering the appearance of the hierpath. For example, history may be presented in a drop-down menu, a list in a window, or some other way.

As noted above, the navigation widget 330 may be used to navigate to various views associated with entities in a model. The views may be different types of views of the model. In other words, the navigation widget 330 may be used to navigate from one type of view to another type of view of the model.

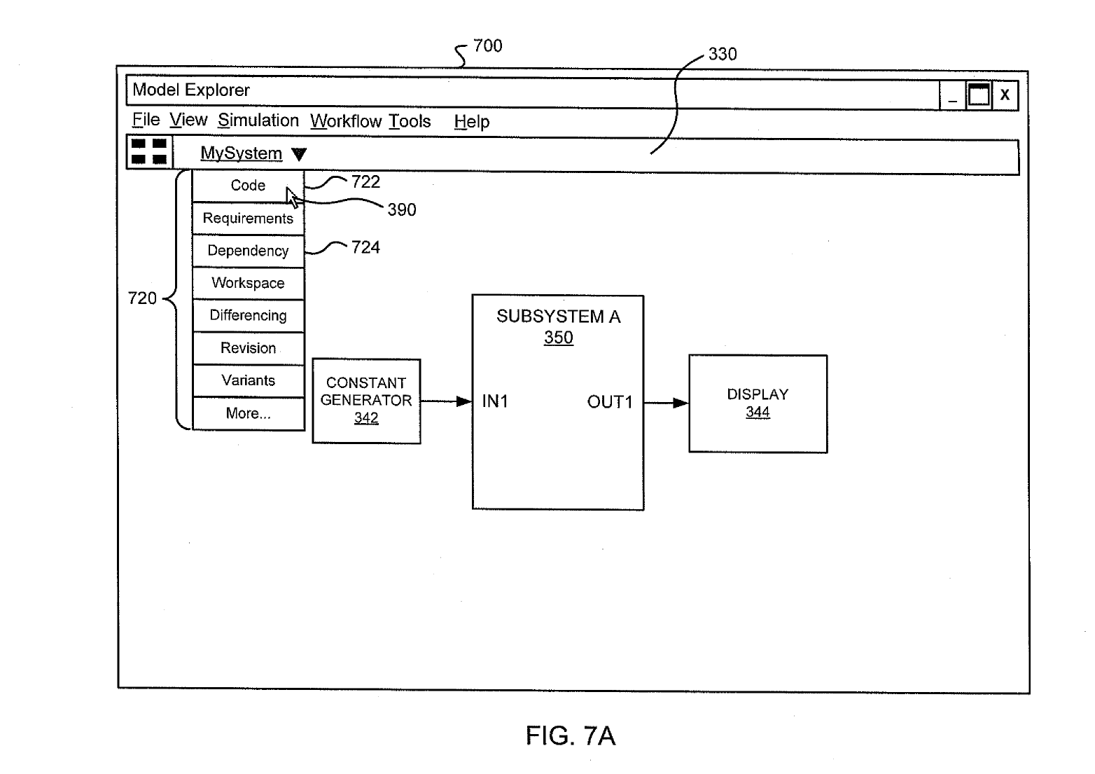

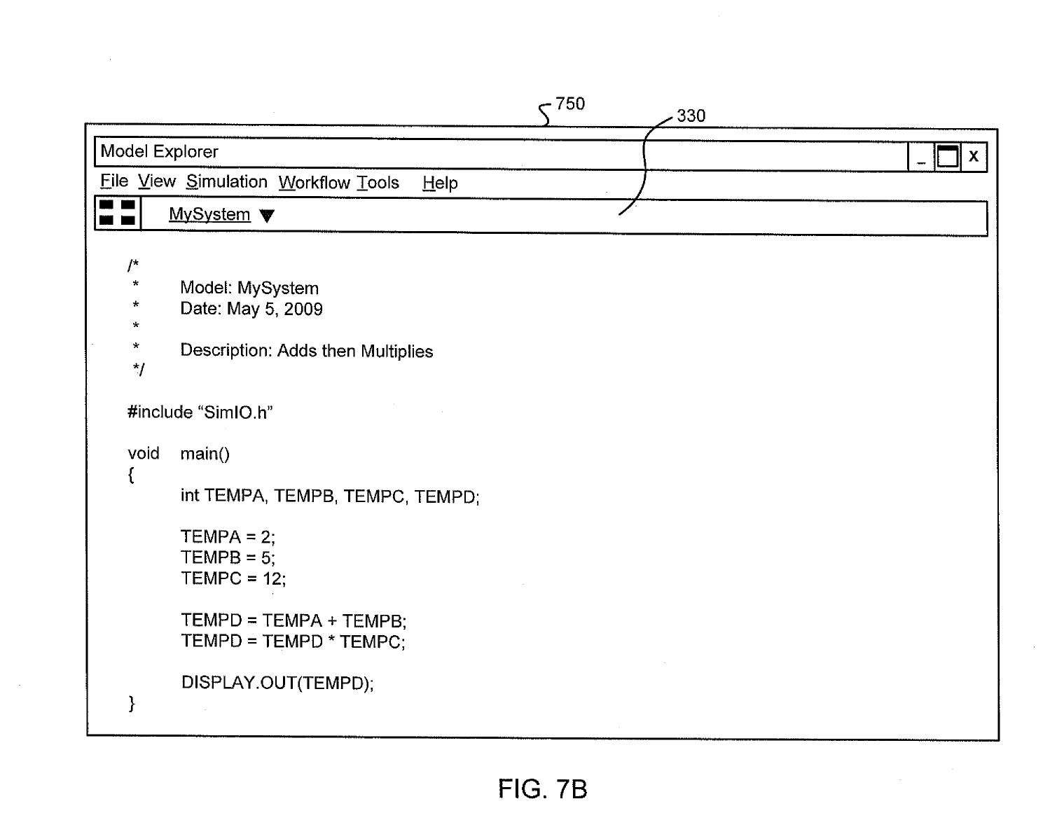

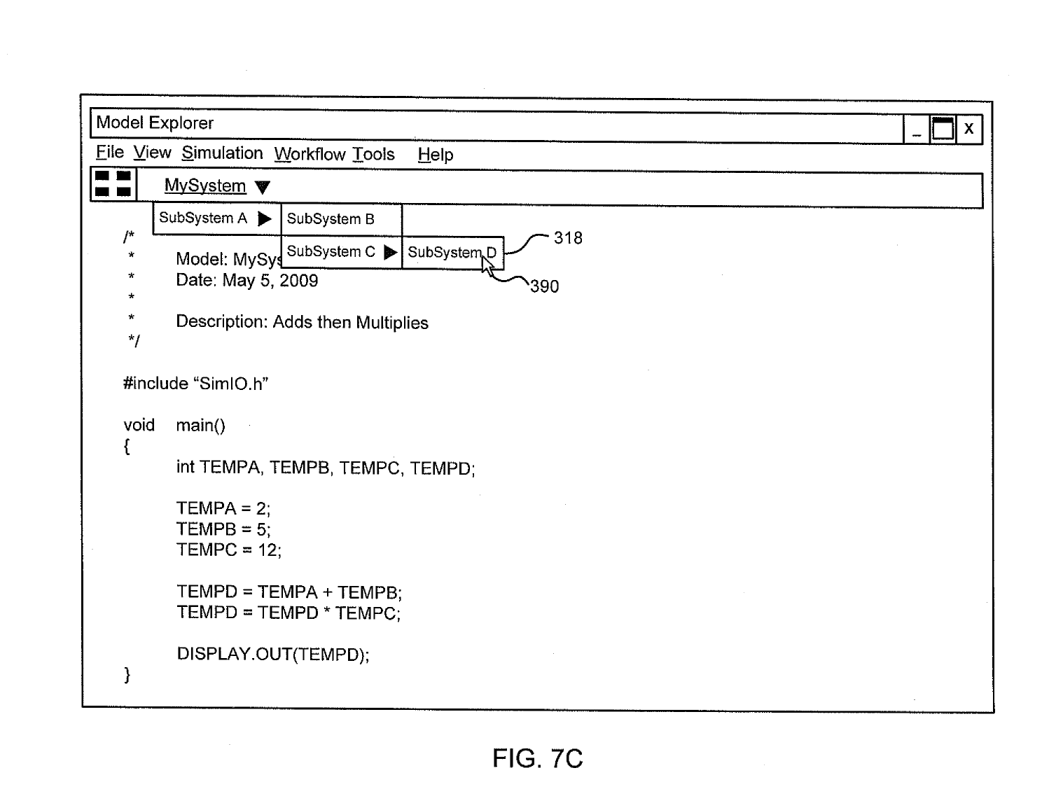

For example, FIGS. 7A-B illustrate navigating from a block diagram view of model 300 to a code view of model 300. Referring to FIG. 7A, a user may use the navigation widget 330 to display a drop-down menu 720 that lists various views that may be navigated to from the current view. These views may include, for example, a code view, requirements view, message sequence chart view, software component view, data type conversion view, dependency view, workspace view, mask workspace view, differencing view, revision view, variants view, or other view. Note that a variant view may be a view that displays variants of one or more portions of a model. A user may select a particular variant from the variant view for use in the model when the model is processed (e.g., executed, compiled, interpreted, etc.).

A user may select the “Code” menu item 722 to navigate to a code view from the block diagram view depicted in FIG. 7A. FIG. 7B illustrates an example code view that may be displayed in response to the user's selection of menu item 722. The view may be displayed in a separate window 750 which depicts code that may be generated by ME 200 for model 300. The window 750 may contain provisions to allow the user to make changes to (e.g., edit) the code. Note that the user may use the navigation widget 330 to navigate from the code view back to the block diagram view illustrated in FIG. 7A in a similar manner. Moreover, other code portions associated with the model, such as output code, setup code, and include code, may be navigated to and/or displayed from the model view. In addition, the user may use the navigation widget 330 to navigate to code views of other portions of the model. The above views may be displayed in separate panes so that they may be viewed simultaneously.

Referring to FIG. 7C, suppose that a user wishes to navigate from a code view of model 300 to a code view of subsystem D 380. The user may navigate to the code view for subsystem D 380 using drop-down menus and selecting menu item 318, as described above. FIG. 7D illustrates a code view for subsystem D 380. Note that the character string “>>>” 780 indicates code that is associated with subsystem D 380 in the view. It should be noted that code associated with a particular portion of a model in a code view of that portion may be indicated in other ways. For example, bolding, flashing, underlining, inverting, coloring, or some other indication may be used to indicate code associated with a particular portion of the model.

Now suppose, for example, that in model 300, subsystem A 350 and subsystem C 370 call routines in a “library E” that, in turn, provides information for subsystem D 380. Referring back to FIG. 7A, further suppose, for example, that a user selects menu item 724 to display a dependency view of model 300.

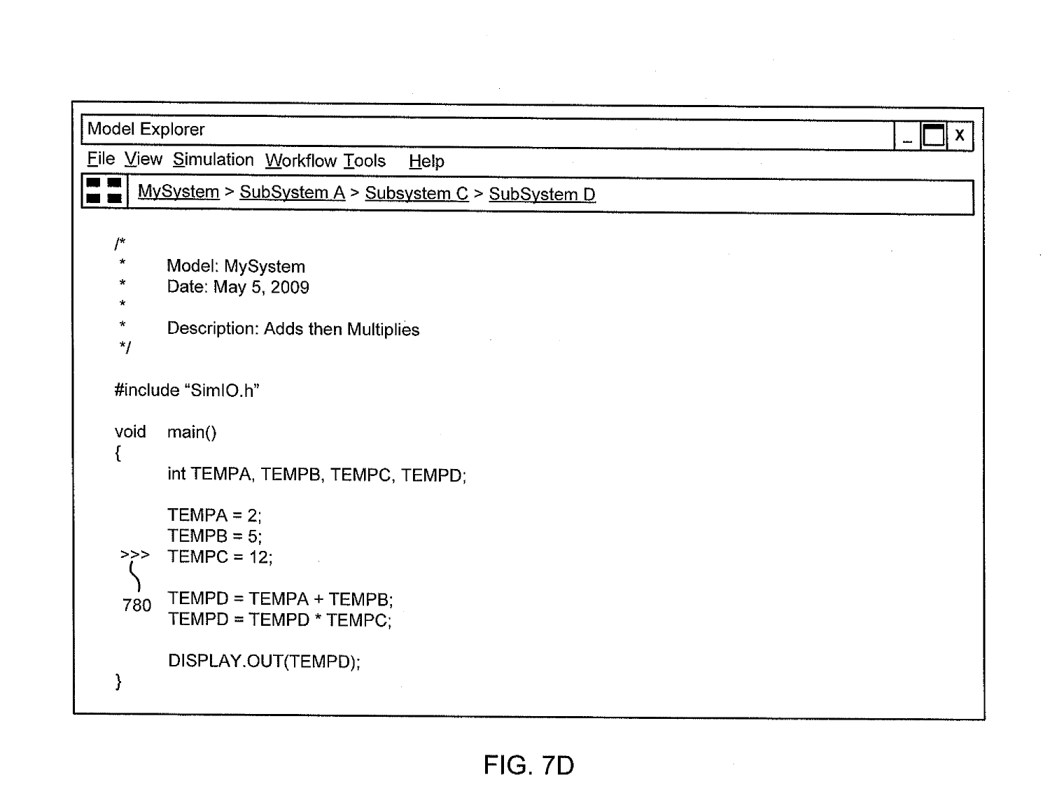

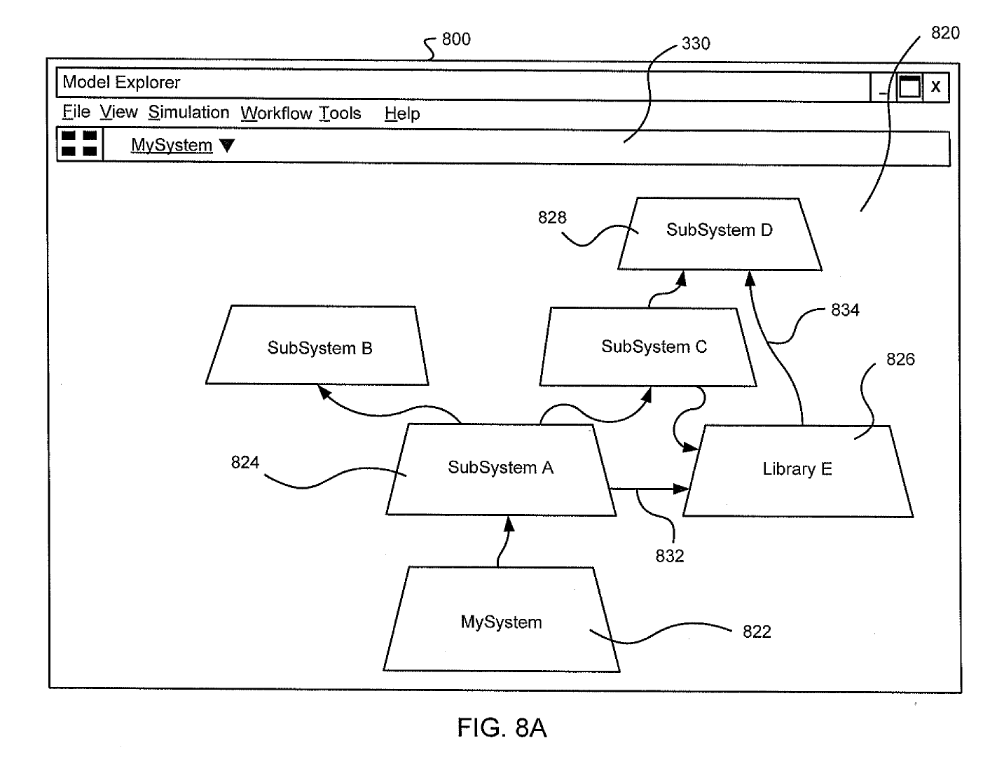

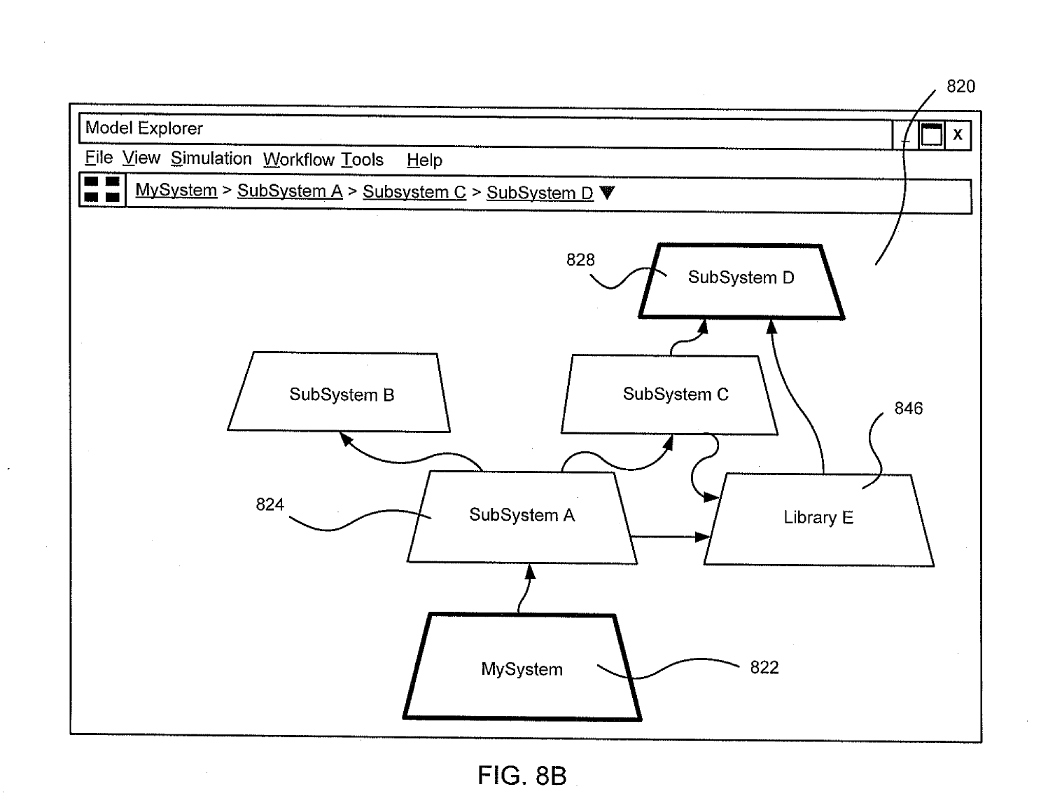

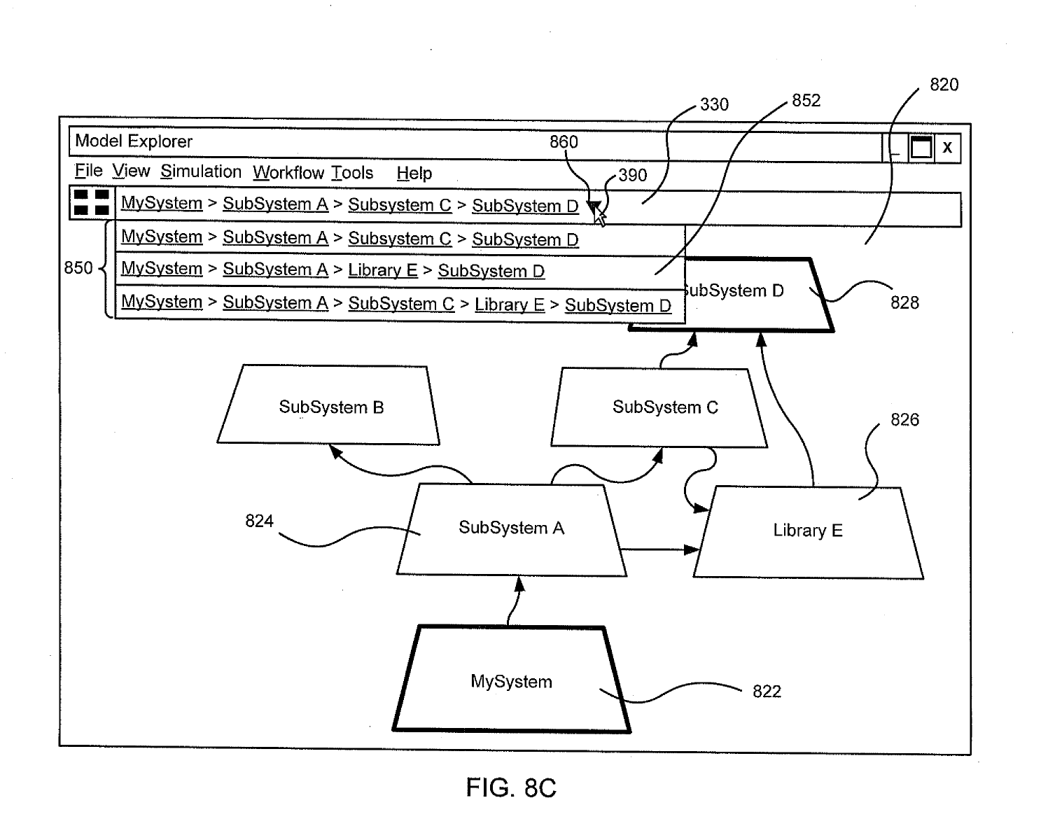

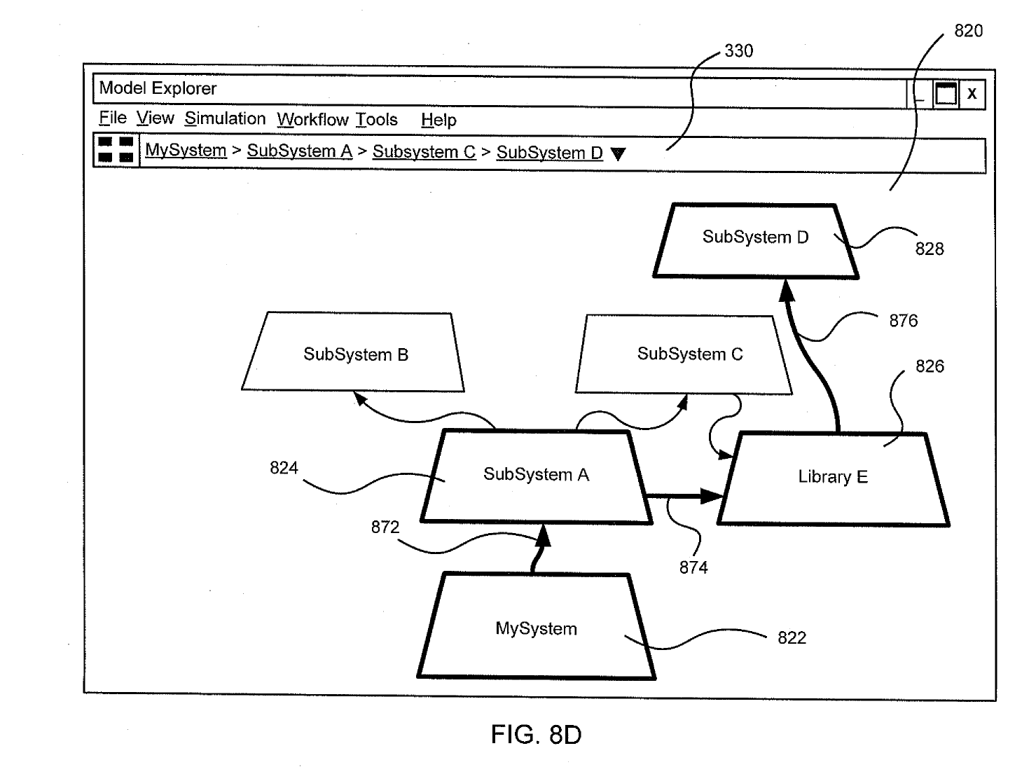

FIG. 8A illustrates an example of a dependency view that may be displayed for model 300 in response to selecting menu item 724. Referring to FIG. 8A, the view contains a dependency diagram 820, which illustrates various dependencies between various entities (e.g., subsystems, libraries, etc.) associated with model 300. In the diagram 820, the entities may be represented by blocks and dependencies between the entities may be represented by arrows. For example, block 822 may be used to represent the entire model 300 as viewed from its topmost level. Likewise, blocks 824 and 826 may be used to represent subsystem A 350 and library E, which in this example are at a level just below the topmost level. In addition, block 828 may be used to represent subsystem D 380, which is three levels below the topmost level. In addition, arrow 832 may be used to indicate a dependency between blocks 824 and 826, and arrow 834 may be used to indicate a dependency between blocks 826 and 828.

Note that entities and dependencies between the entities in a dependency view may be represented in other ways. For example, the representation of a dependency may differ depending on a type of the dependency. Also, only specific types of dependencies may be shown, such as, for example, library dependencies, subsystem dependencies, or other entity dependencies.

Referring to FIG. 8B, model navigator 246 may contain provisions to enable a user to select two or more entities in diagram 820. As depicted in FIG. 8B, blocks 822 and 828 are selected as a beginning entity and an ending entity, respectively. Referring now to FIG. 8C, the navigation widget 330 may include a drop-down menu button 860 which may enable a user to view a list of hierpaths 850 that may represent dependencies between the selected blocks 822 and 828. Note that specifying different selected blocks may cause different hierpaths to be displayed in the list 850.

A user may select an entry in the list 850 and in response to a selection, the model navigator 246 may indicate a dependency represented by the selected entry on the diagram 820. Entities (e.g., blocks, arrows) associated with the dependency may be indicated on the diagram 820 using, for example, highlighting, bolding, flashing, underlining, inverting, coloring, low-lighting, or some indication. Alternatively, the dependency may be indicated by changing the display of entities not represented by the dependency. For example, the dependency may be indicated by maintaining the display of the entities in the dependency and graying-out (low-lighting) or some other indication of entities not represented by the dependency. After the dependency is indicated in the diagram 820, the user may then be able to navigate to a particular portion of the model by selecting a block in the indicated dependency.

For example, suppose the user selects menu item 852. Referring now to FIG. 8D, the selected hierpath “MySystem>SubSystem A>Library E>SubSystem D” would be indicated in the diagram 820. In this example, blocks 822, 824, 826, and 828, and arrows 872, 874, and 876 are bolded to indicate the dependency represented by the selected hierpath. A block in the indicated dependency represented by the selected hierpath may be further selected to navigate to a view associated with the block. For example, selecting (e.g., double-clicking) block 826 may cause a code view of Library E to be displayed. Moreover, selecting block 824 may cause the model navigator 246 to navigate to subsystem A 350 and display a block diagram view of the subsystem 350, such as depicted in FIG. 3B.

It should be noted that a model may be navigated in other ways using a dependency diagram. For example, referring back to FIG. 8A, in response to selecting a block in the dependency diagram 820, a menu, such as menu 720, listing different views associated with the block that may be navigated to may be displayed. A menu item may be selected in the menu to specify a view associated with the block to navigate to. In response to the selection, the model navigator 246 may navigate to the selected view and may display the view.

As noted above, navigation widget 330 may include a button 332 that may be used to display a hierarchical display of a model. FIG. 9 illustrates an example of a hierarchy display 920 of model 300 that may be displayed using button 332.

Specifically, a user may select the button 332 by, for example, clicking on the button 332 with a pointing device, hovering a cursor, such as cursor 390, over the button 332, or selecting the button 332 some other way, such as via a keyboard. In response to selecting the button 332, hierarchy display 920 may be displayed.

The hierarchy display 920 may be used to navigate through the model. For example, selecting an entity, such as block 924, may cause the model navigator 246 to navigate to subsystem A 350. In addition, the model navigator 246 may display a view of subsystem A 350.

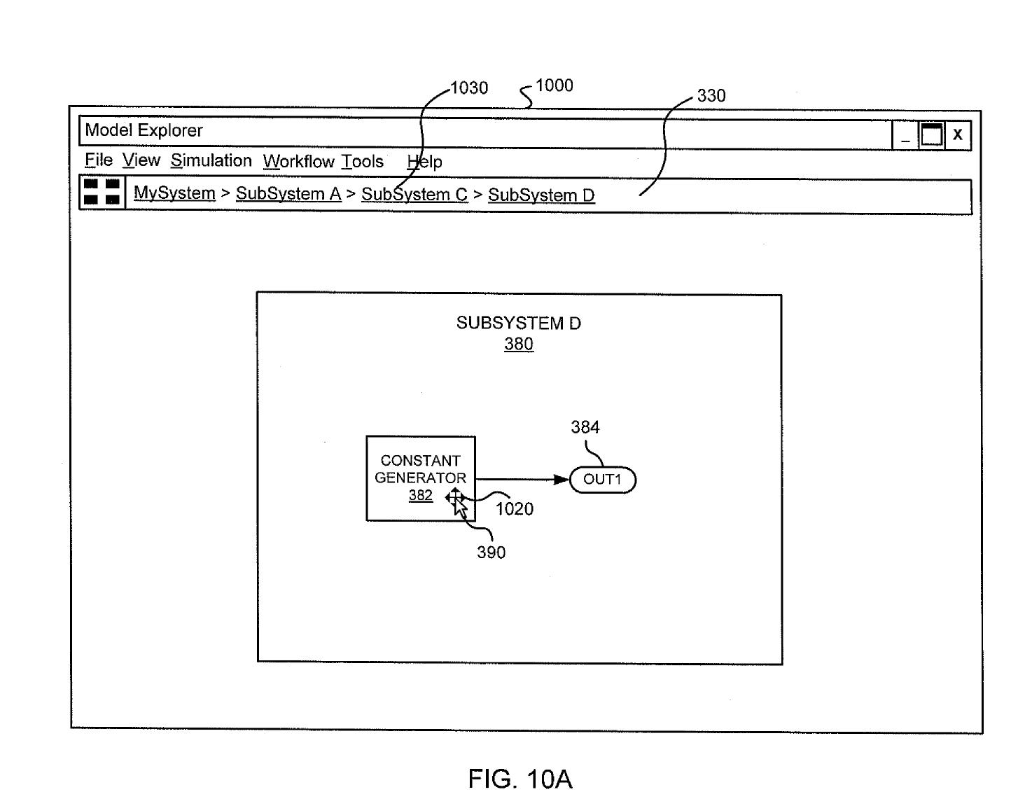

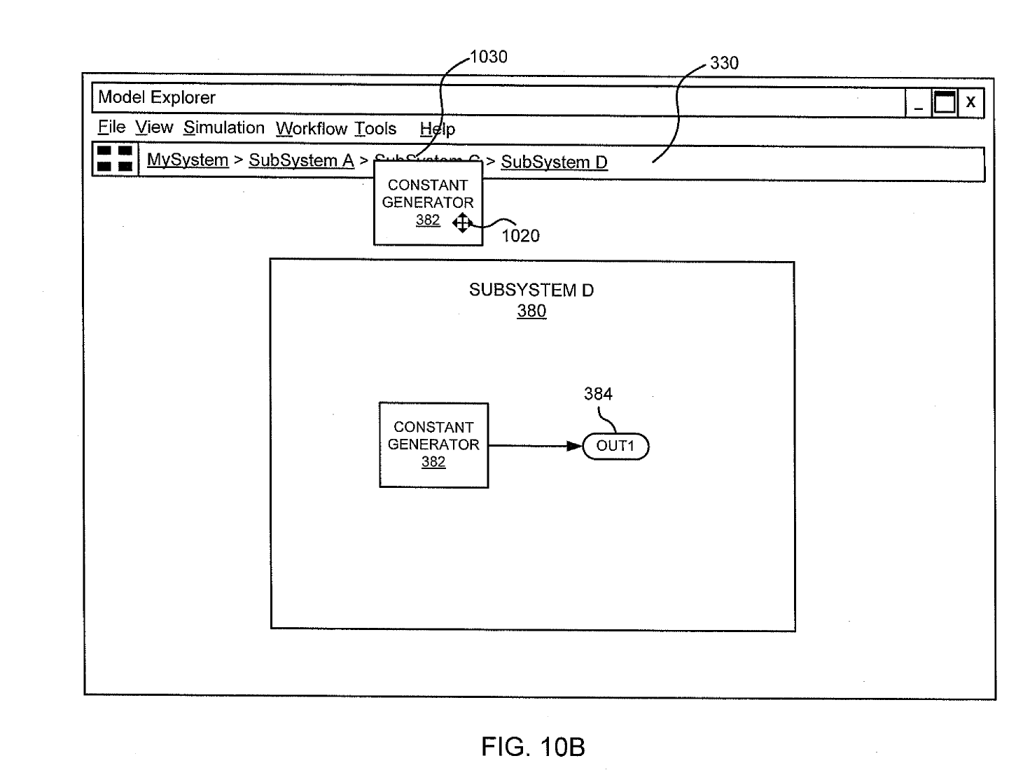

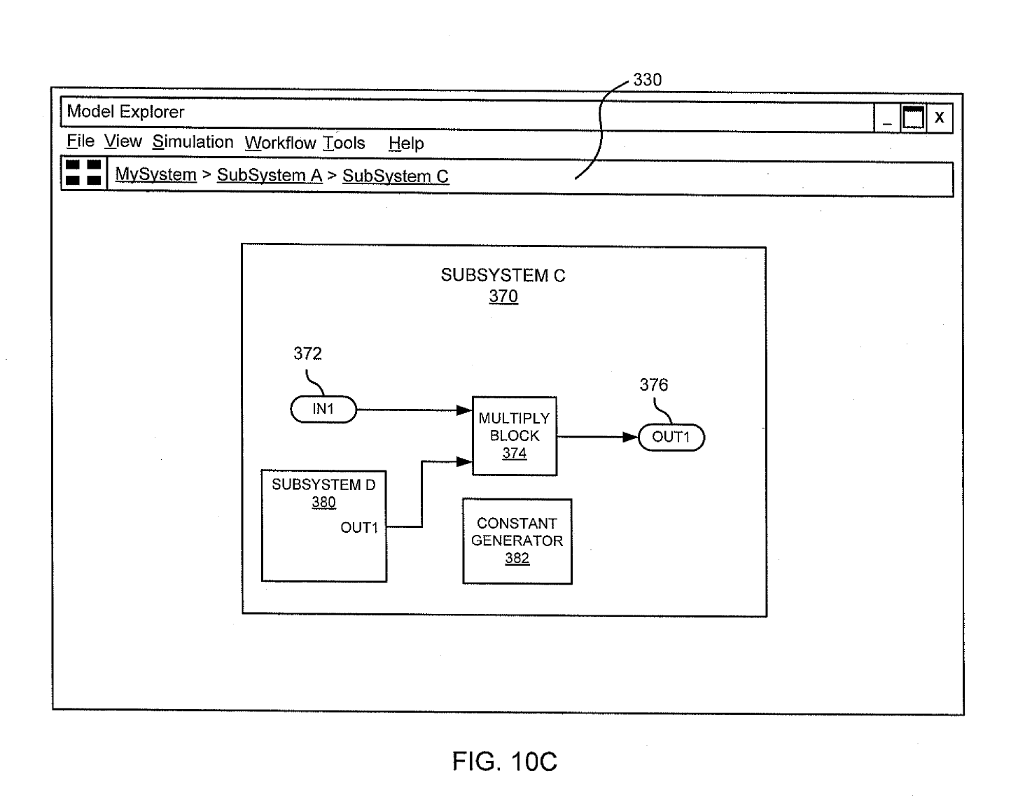

Navigation widget 330 may be used to add entities that are at one level in a model to another level in the model by, for example, copying or moving the entities. FIGS. 10A-C illustrate an example of adding a graphical entity from a first level in a model to a second level in the model using navigation widget 330.

Referring to FIG. 10A, suppose a user wishes to add a copy of constant generator 382 to subsystem C 370, which is represented in the hierpath by the text “SubSystem C” 1030. The user may select constant generator block 382 in subsystem D 380 and the selection may be indicated using a special cursor, such as cursor 1020. Note the selection may be indicated in other ways, such as described above.

Referring now to FIG. 10B, the user may add the generator block 382 to subsystem C 370 by, for example, dragging a copy of constant generator block 382 to text 1030 in the hierpath displayed in the navigation widget 330 and dropping the block 382 on the text 1030. In response, the model navigator 246 may add block 382 to subsystem C 370. In addition, the model navigator 246 may add a link (e.g., a reference) between block 382 in subsystem D 380 and block 382 in subsystem C 370. This may enable changes to one block to be propagated to the other.

FIG. 10C illustrates a block diagram view of subsystem C 370 with the added constant generator block 382. The block diagram view may be automatically displayed, for example, in response to dropping the block 382 on the text 1020. After the block 382 is added, the user may utilize the block 382 in the subsystem 370. For example, the user may remove the subsystem D block 380 from the diagram and replace it with the constant generator block 382 that has just been placed in the subsystem 370.

Note that the block may be added to other levels in the model indicated in the hierpath. For example, dropping the block on the text “SubSystem A” in the hierpath would cause the block to be added to subsystem A 350. It should be noted that if a block is added to another level in the model, the block may be removed from its original level. Moreover, the block may be maintained at its original level and a reference to the block may be created at the other level.

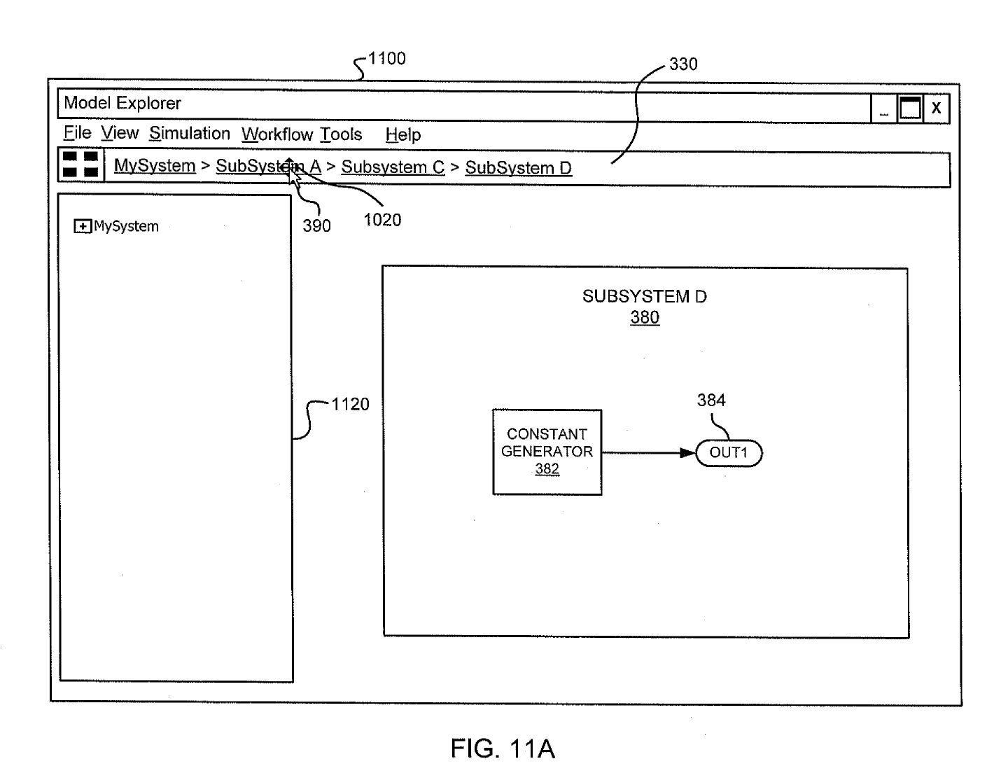

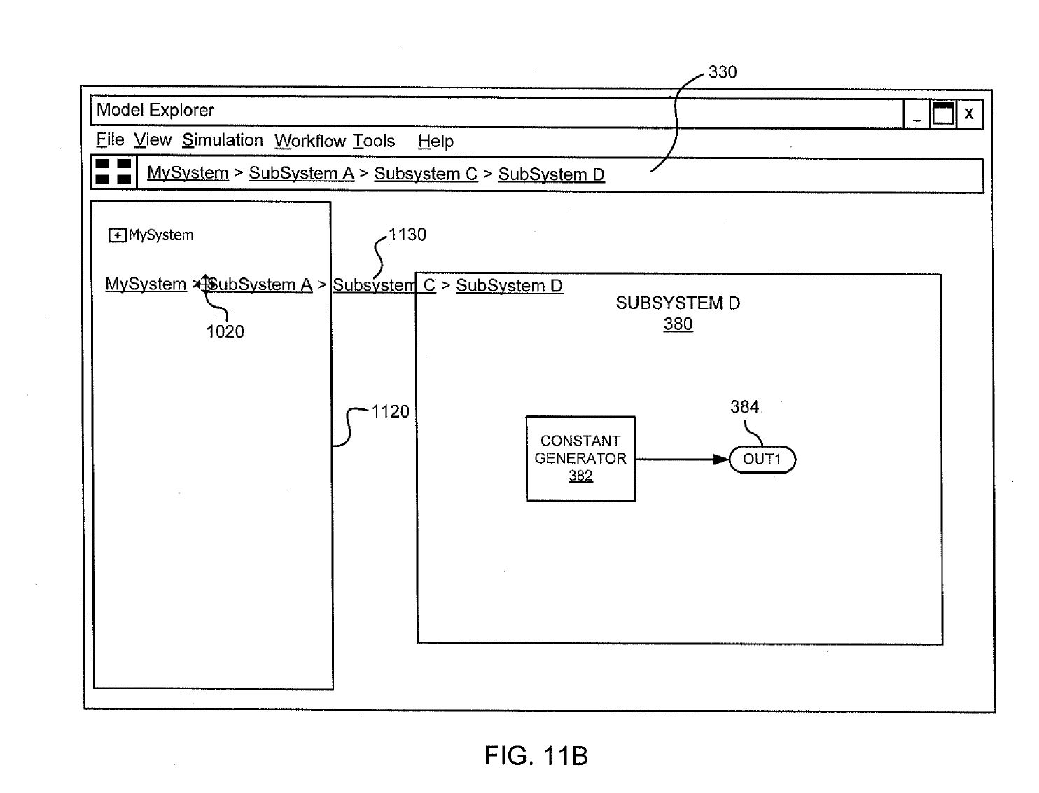

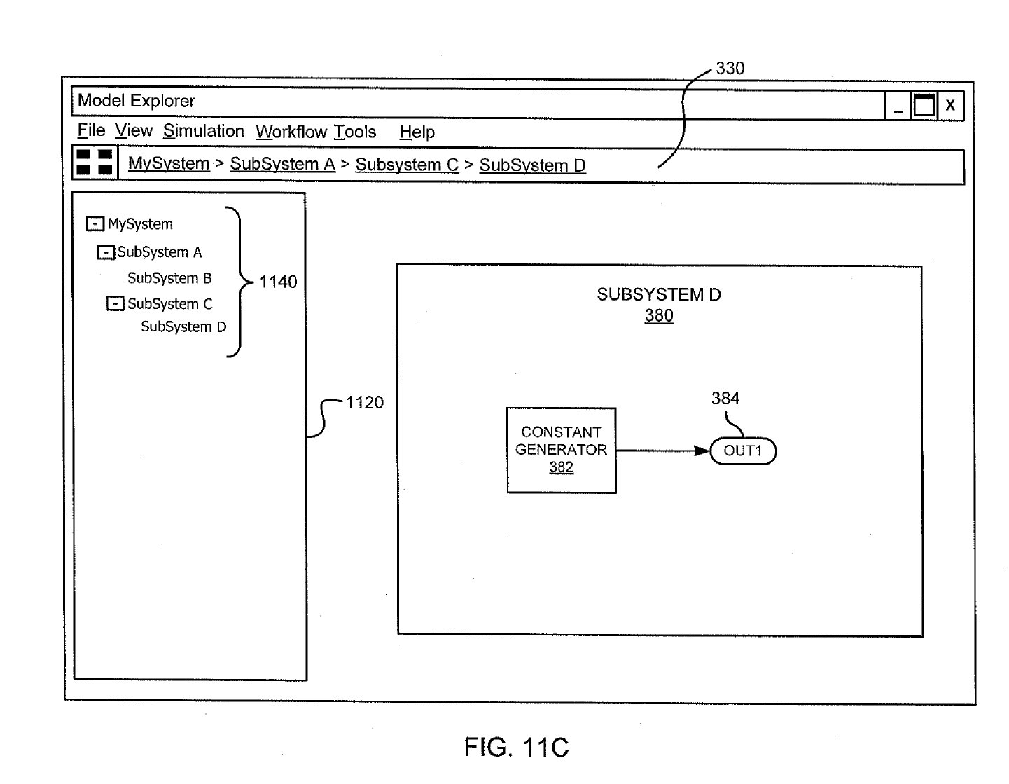

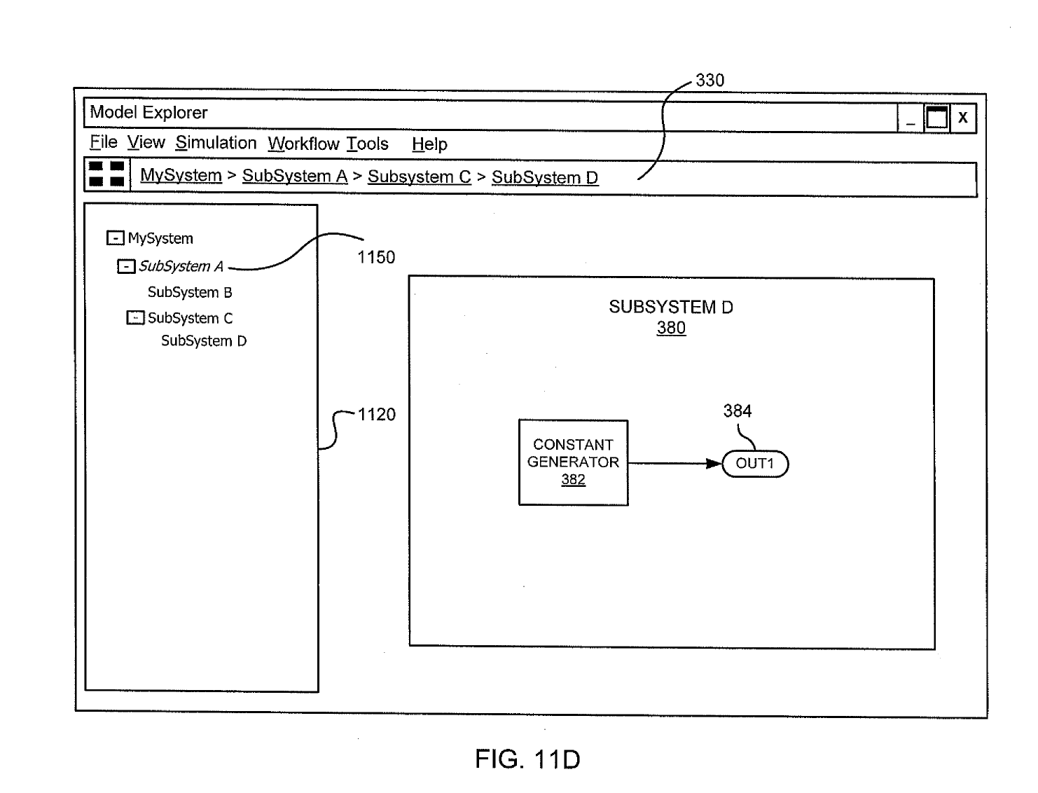

A hierpath may be used to expand information that has a relation with the hierpath to be in synchronization with the hierpath. The information may be a tree view of a model. For example, FIGS. 11A-D illustrate an example of expanding a tree view 1120 of model 300 using the hierpath displayed in navigation widget 330. FIG. 11A includes a block diagram of subsystem D 380 in model 300. The tree view 1120 reflects an unexpanded hierarchical tree view of model 300. Note that only the topmost level in the hierarchy, i.e., “MySystem” is displayed in the tree view 1120.

A user may position cursor 390 to the hierpath displayed in navigation widget 330. The user may then indicate that the hierpath is being selected. For example, after positioning the cursor 390 over the hierpath the user may click a button on pointing device and hold the button down to indicate the hierpath is being selected. An indication may be provided, such as cursor 1020, to indicate the hierpath is selected. The user may then use the pointing device to drag the selected hierpath 1130 onto the tree view 1120, as shown in FIG. 11B. The user may then “drop” the selected hierpath 1130 onto the tree view 1120 to expand the tree view 1120 to display a tree of the hierarchy as represented by hierpath and to synchronize the tree view 1120 with the hierpath. This is illustrated in FIG. 11C. Here, the tree 1140 may be displayed in response to dropping the hierpath onto the tree view 1120.

Also, only part of the current hierpath may be dragged over. Here, the user may use the pointing device to highlight a portion of the hierpath or the user may click on a portion of the hierpath to be dragged. This portion may be dropped on the tree and the tree may expand only up to the portion of the hierpath that is dropped on the tree. For example, suppose the user uses the pointing device to highlight the text “SubSystem C” in the hierpath. The user may drag this portion of the hierpath to the tree view 1120 and drop it on the tree view 1120. The tree view 1120 may only expand up till “SubSystem C” and “SubSystem D” would not be visible in the tree view 1120.

In some instances it may be helpful to identify certain conditions associated with levels in a model's hierarchy and provide an indication of whether these identified conditions are satisfied or not satisfied in a tree view, such as tree view 1120. For example, as noted above, a user may want to know which levels in a model's hierarchy contain strictly virtual blocks, strictly non-virtual blocks, or some other condition. FIG. 11D illustrates tree view 1120 where the text “SubSystem A” 1150 is displayed differently (i.e., italicized) to indicate that subsystem A 350 contains only virtual blocks. It should be noted that other ways of indicating whether a condition is satisfied or not satisfied may be used including highlighting, bolding, flashing, underlining, inverting, coloring, using symbols, icons, or some other indication.

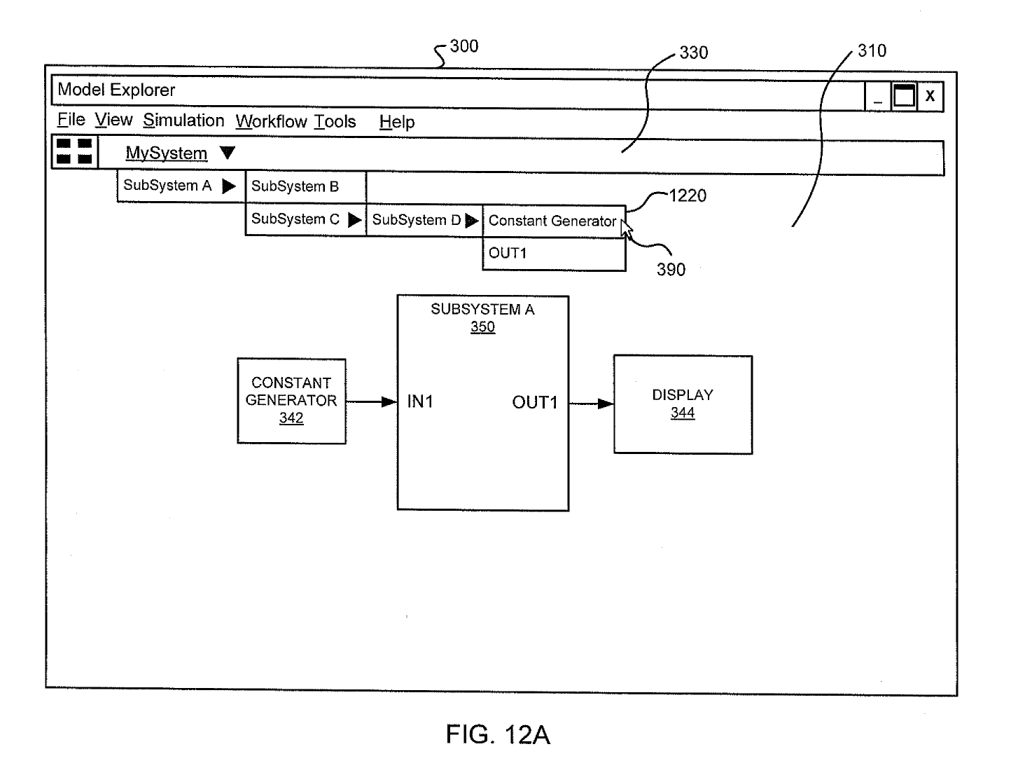

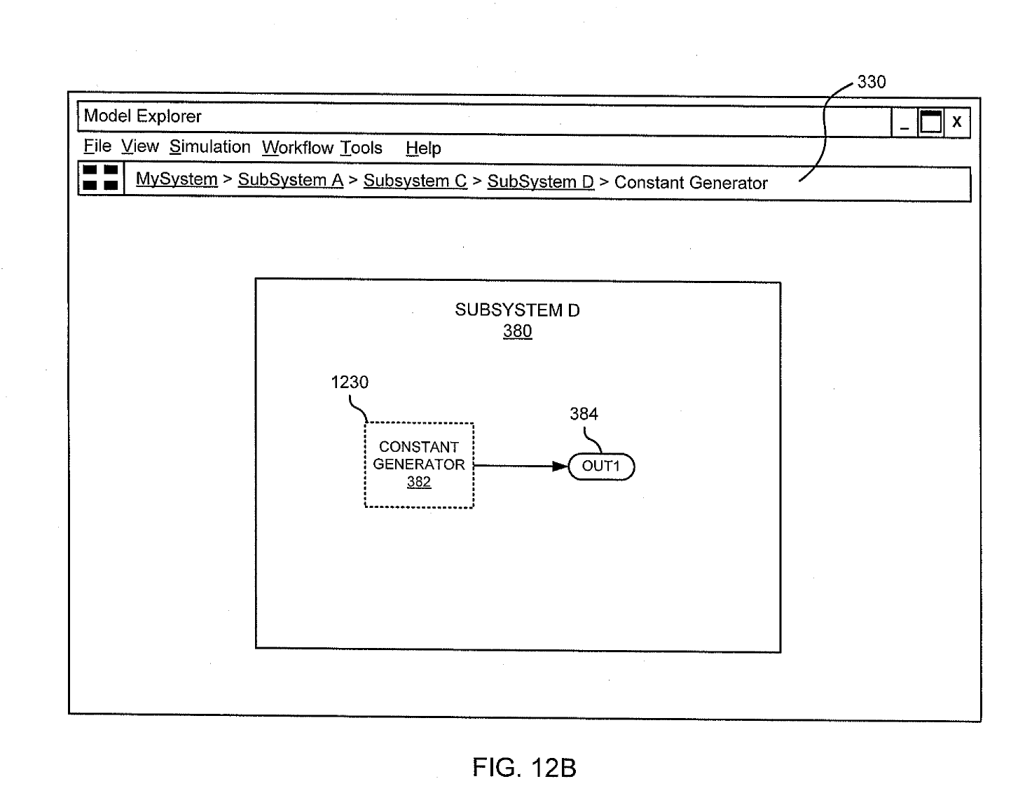

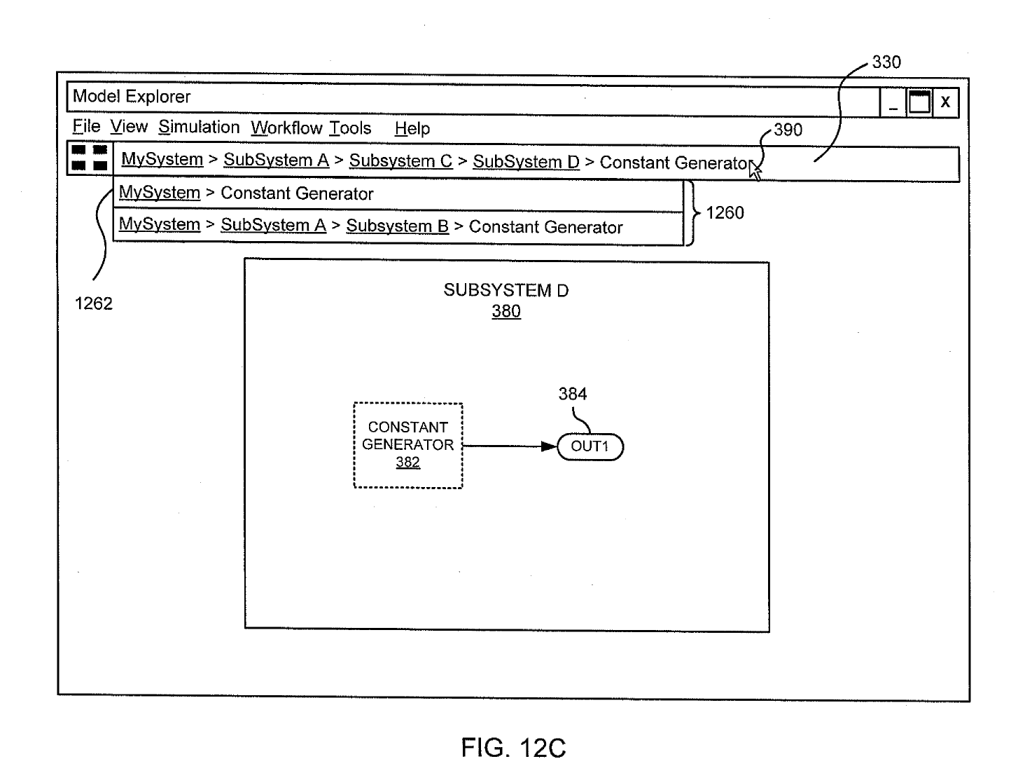

As noted above, entities in a model that may be navigated to may include blocks in the model. FIGS. 12A-C illustrate examples of using navigation widget 330 to navigate to blocks in model 300. As noted above, subsystem D 380 contains a constant generator block 382 and an outport block 384.

Referring to FIG. 12A, suppose that model navigator 246 is currently navigated to the topmost level of model 300, i.e., “MySystem”. Now suppose that a user wishes to use navigation widget 330 to navigate to constant generator block 382 from the topmost level. The user may select to navigate to constant generator block 382 using a series of drop-down menus, as indicated in FIG. 12A. The user may position cursor 390 to menu item 1220 to select the constant generator block 382. In response the model navigator 246 may navigate to generator block 382 and display subsystem D 380, as illustrated in FIG. 12B. Note that the hierpath displayed in the navigation widget 330 is updated to include the hierpath to the constant generator block 382. In addition, the model navigator 246 may or may not provide a visual indication in the displayed block diagram that indicates the constant generator 382 has been navigated to. In this example, a visual indication, i.e., a dotted outline 1230, for constant generator block 382 is provided. It should be noted that other visual indications may be used, including, but not limited to, highlighting, bolding, flashing, underlining, inverting, coloring, displaying one or more graphics within the block, or some other visual indication.

The navigation widget 330 may be used to navigate to other portions in the model that contain one or more blocks that are similar to the block currently navigated to. For example, referring to FIG. 12C, suppose that after navigating to constant generator block 382, that a user wishes to navigate to another constant generator block in the model 300. The user may provide an indication that the user wishes to view a list of other constant generator blocks in model 300. In response to the indication, the navigation widget 330 may display a list 1260 of other locations in the model that contain a constant generator block. The user may then select an item in the list 1260 to navigate to the constant generator block associated with the item. For example, the user may select item 1262 to navigate to constant generator block 342. Note that the similarity may also be based on a name of a block as well as references between blocks.

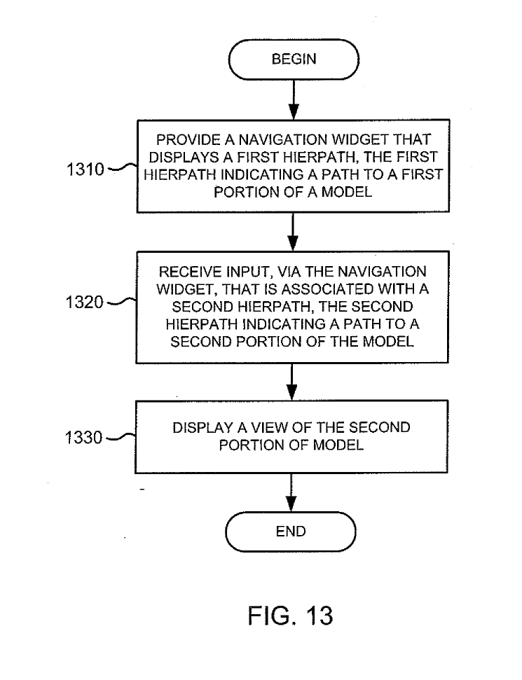

FIG. 13 illustrates a flow chart of example acts that may be used to navigate a model, such as model 300, using a navigation widget, such as navigation widget 330. Referring to FIG. 13, at block 1310, a navigation widget is provided that displays a first hierpath, which indicates a path to a first portion of the model. The navigation widget may be provided by displaying the widget in a window, such as, for example window 310. The window may be displayed by a model navigator, such as model navigator 246.

At block 1320, input, that is associated with a second hierpath, is received, via the navigation widget. The second hierpath indicates a path to a second portion of the model. Here, the input may be a selection of a menu item in a menu (e.g., a drop-down menu), a selection of a hyperlink that is included in the first hierpath, text entered into a text box, or some other input that is received, for example, from a GUI, a file, a data structure, etc.

At block 1330, a view of the second portion of the model is displayed. The view may include, for example, a block diagram view, code view, requirements view, message sequence chart view, software component view, data type conversion view, dependency view, workspace view, mask workspace view, differencing view, revision view, variants view, custom view, or some other view. The view may be displayed in response to receiving the input associated with the second hierpath.

For example, referring to FIGS. 1, 3A, 3B, 3D, and 13, suppose a user wishes to navigate from the topmost level of model 300 (i.e., MySystem) to subsystem A 350. Model navigator 246 may display window 310 which includes a block diagram of model 300 and navigation widget 330 on an output device 170 (block 1310). The user may use an input device 160 to position cursor 390 to button 336 in the navigation widget 330 and select the button 336. The model navigator 246 may respond to the button selection by displaying a drop-down menu containing menu item 338 on the output device 170. The user may then use the input device 160 to position cursor 390 to menu item 338 and select menu item 338. The model navigator 246 may receive the selection via OS 132 (block 1320). After receiving the selection, the model navigator 246 may navigate to subsystem A 350. The model navigator 246 may then display a block diagram view of system A 350, as depicted in FIG. 3B, on output device 170 (block 1330).

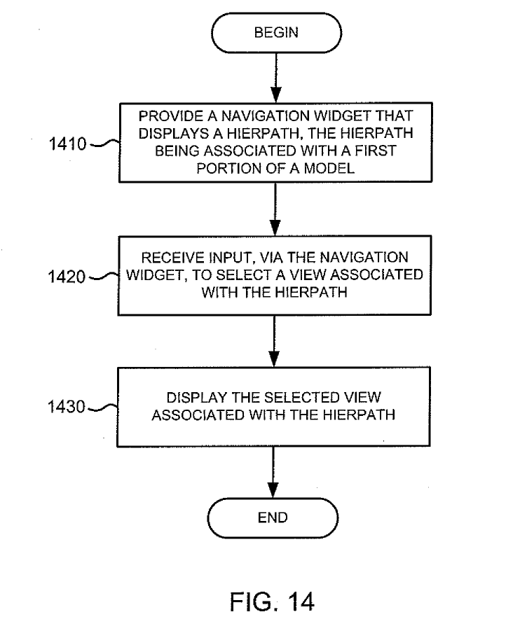

FIG. 14 illustrates a flow chart of example acts that may be used to display a selected view of a model using a navigation widget. Referring to FIG. 14, at block 1410, a navigation widget that displays a hierpath is provided, where the hierpath is associated with a first portion of the model. As noted above, the navigation widget may be provided by being displayed in a window, such as window 310.

At block 1420, input regarding a selection of a view associated with the hierpath is received. The input may be received, for example, via the navigation widget. The input may include a selection of a menu item from a drop-down menu that lists various types of views that can be displayed, such as menu 720 described above. The drop-down menu may be displayed in response to selecting the hierpath displayed in the navigation widget. At block 1430, the selected view associated with the hierpath is displayed.

For example, referring to FIGS. 1, 7A, 7B, and 14, suppose that a user wishes to display a code view of model 300 as depicted in FIG. 7A. Referring to FIG. 7A, model navigator 246 may display window 700 including navigation widget 330 (block 1410) on output device 170. The user may use input device 160 to position cursor 390 to the hierpath displayed in navigation widget 330. The user may then click on the hierpath, using the input device 160, to indicate that drop-down menu 720 should be displayed. In response, the model navigator 246 may display drop-down menu 720 on output device 170. Using the pointing device 160, the user may position cursor 390 to item 722 in the menu 720 and select the item 722. The model navigator 246 may receive the selection (block 1420) and in response to the selection display code view 750 on output device 170 (block 1430).

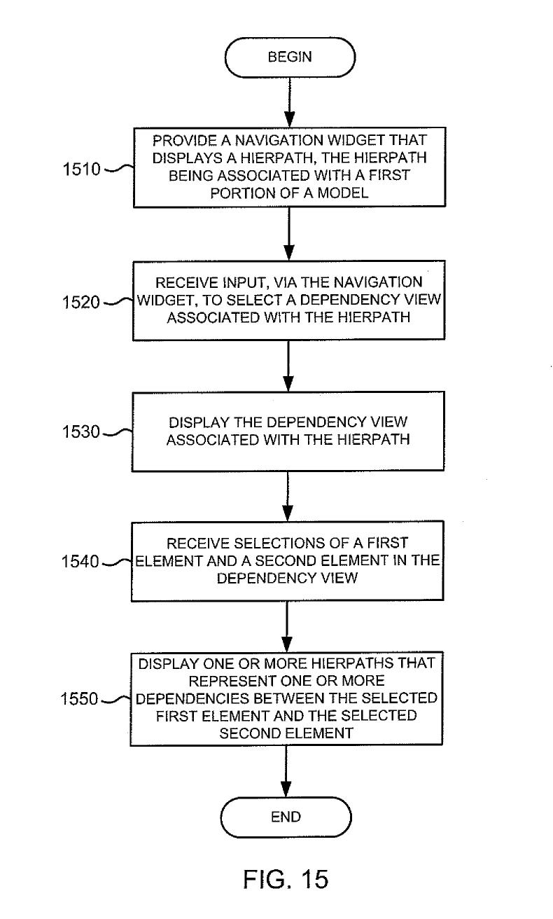

FIG. 15 illustrates a flow chart of example acts that may be used to display a selected dependency view of a model using a navigation widget. At block 1510, a navigation widget is provided where the navigation widget displays a hierpath associated with a first portion of a model. The navigation widget may be a widget that is provided (e.g., displayed) in a window on an output device, such as output device 170. The window may be displayed by a model navigator, such as model navigator 246.

At block 1520, input is received via the navigation widget where the input specifies a selection of a dependency view associated with the displayed hierpath. The input may be, for example, a menu item in a drop-down menu.

For example, a pointing device may include three buttons, a left button, a center button, and a right button. A user may use the pointing device to position a cursor over the displayed hierpath. The user may then press a button on the pointing device (e.g., the right button) to display a drop-down menu that contains one or more menu items associated with various views that may be displayed for a model. The user may position the cursor on an item in the drop-down menu that may be used to display a dependency view of the model. The user may select the item by pressing a button on the pointing device (e.g., the left button).

At block 1530, the dependency view is displayed. As noted above, the dependency view may include blocks that represent entities in the model and arrows that represent dependencies between the entities. At block 1540, a selection of a first element (e.g., block) and a second element in the dependency view is received. The first and second elements may be selected, for example, by clicking on the elements using a pointing device, as described above.

At block 1550, one or more hierpaths that represent dependencies between the selected first and second elements are displayed. As noted above, the hierpaths may be displayed in a list that may be part of a drop-down menu or a window. Moreover, the hierpaths may be displayed (e.g., indicated) in the dependency view.

For example, referring to FIGS. 1, 7A, 8A-D, and 15, model navigator 246 may display window 700 (FIG. 7A) on an output device 170 (block 1510). A user may use an input device 160 to position cursor 390 over the hierpath displayed in navigation widget 330 in window 700. The user may select a button on the input device 160 to display drop-down menu 720. The user may then select menu item 724 to display a dependency view of model 300 (block 1520).

The model navigator 246 may receive the user's selection and in response to the user's selection, the model navigator 246 may display window 800 on the output device 170 (block 1530). The user may select blocks 822 and 826, as shown in FIG. 8B (block 1540). Referring to FIG. 8C, in response to selecting the blocks, model navigator 246 may display button 860 on the output device 170. Using the input device 160, the user may position cursor 390 to the button 860 and select the button 860. In response to the selection, the model navigator 246 may display list 850 on the output device 170 (block 1550). The user may then select item 852 in the list 850 using the input device 160. The model navigator 246 may display an indication of the selected dependency in the dependency diagram 820, as illustrated in FIG. 8D, on the output device 170.

Alternatively or in addition to, after the user has selected block 822 and 826, in addition to or instead of displaying list 850, model navigator 246 may display an indication of one or more of the dependencies in the dependency diagram 820 on the output device 170.

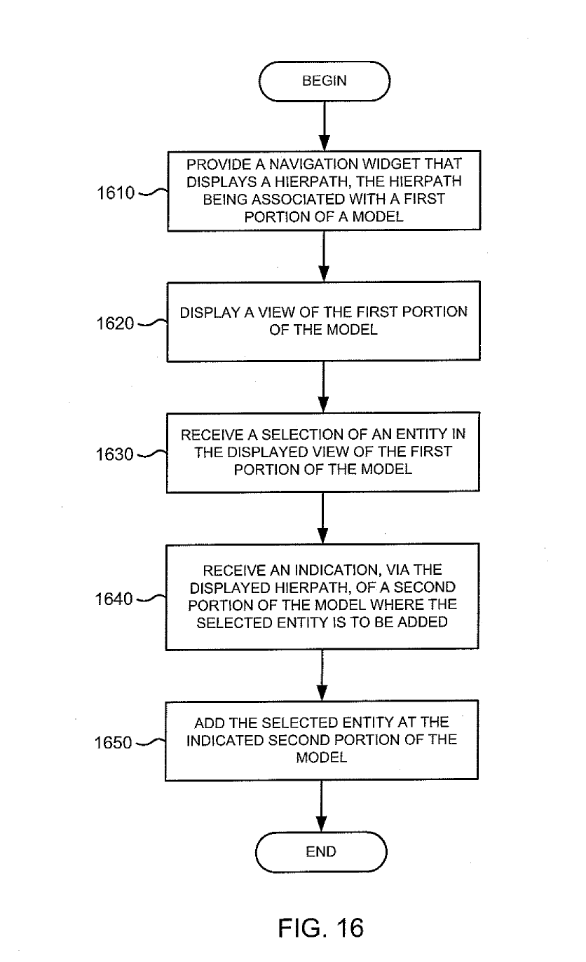

FIG. 16 illustrates a flow chart of example acts that may be used to copy an entity from a first portion of a model to a second portion of the model using a hierpath displayed by a navigation widget. Referring to FIG. 16, at block 1610, a navigation widget that displays a hierpath that is associated with the first portion of the model, is provided. The navigation widget may be provided (e.g., displayed) by model navigator, such as model navigator 246.

At block 1620, a view of the first portion of the model is displayed. The view may be, for example, a block diagram view of the first portion. At block 1630, a selection of an entity in the displayed view of the first portion is received. For example, the view may be a block diagram view and the selection may be a selection of a block in the block diagram view. A user may select the block by using a pointing device to position a cursor over the block and holding down a button on the pointing device.

At block 1640, an indication of a second portion of the model where the selected entity is to be added is received via the hierpath. In the above example, the user may use the pointing device to “drag” the selected block over text in the displayed hierpath, that is associated with a level where the block is to be added, to indicate a second portion of the model where the selected entity is to be added. At block 1650, the selected entity is added (e.g., copied, moved) to the indicated second portion of the model. Note that, as noted above, a reference between the added and original block may be established. This may enable changes made to the one block may be automatically adopted by the other. In addition, note that the entity may be removed from the first portion of the model. Here, the entity may be removed when the entity is dragged to the displayed hierpath. Alternatively, the entity may be removed after it has been added to the second portion of the model.

The following illustrates an example of applying the above to model 300. Referring to FIGS. 1, 10A-C, and 16, suppose, for example, that a user wishes to add constant generator block 382 from subsystem D 380 to subsystem C 370 in model 300. Model navigator 246 may provide navigation widget 330 by displaying window 1000, which contains the navigation widget 330 (block 1610) and a block diagram view of subsystem D 380. The user may use an input device 160 to position cursor 390 to constant block 382 and select the block 382 by, for example, pressing and holding a button associated with the input device 160. The model navigator 246 may receive the user's selection (block 1630).

The user may then “drag” a copy of the constant generator block 382 to text 1020 in the hierpath to indicate that a copy of the block 382 is to be placed in subsystem C 370. The model navigator 246 may receive this indication via OS 132 (block 1640) and in response to the indication may add block 382 to subsystem C 370 (block 1650). In addition, the model navigator 246 may automatically navigate to subsystem C 370 and display a block diagram view of subsystem C 370 showing the added block 382, as illustrated in FIG. 10C, on an output device 170. Note that the above may involve simultaneous navigating and editing of the model.

FIG. 17 illustrates a flow chart of example acts that may be used to synchronize a tree view (e.g., hierarchical tree view) of a model with a hierpath. Referring to FIG. 17, at block 1710, a navigation widget is provided that displays a hierpath. The navigation widget may be provided (e.g., displayed) as described above.

At block 1720, a tree view of a second portion of the model is displayed. The tree view may, for example, be included in a window, which may be separate from or the same window that also includes the navigation widget. At block 1730, an indication to synchronize the tree view with some or all of the displayed hierpath is received. The indication may be, for example, dragging and dropping some or all of the hierpath onto the tree view, a command (e.g., received via a menu), or some other indication. The indication may be received by a model navigator which may perform the synchronization. At block 1740, in response to receiving the indication, the tree view is updated based on the hierpath. Specifically, the tree may be updated to display a tree view of the first portion of the model represented by the hierpath. Thus, the tree view is synchronized with the hierpath.

For example, referring to FIGS. 1, 11A-C, and 17, the ME 200 (FIG. 1) may display window 1100 on output device 170 to provide navigation widget 330 (block 1710). In addition, model navigator 246 may display tree view 1120 that presents a tree view of the top-level view of model 300 (block 1720) on output device 170.

Referring to FIG. 11A, a user may use an input device 160 to select the hierpath displayed in the navigation widget 330, as described above. The user may then, using the input device 160, drag the hierpath to the tree view 1120 and drop the hierpath in the tree view 1120 as illustrated in FIG. 11B (block 1730). In response to the user dropping the hierpath in the tree view 1120, the model navigator 246 may synchronize the tree view 1120 with the hierpath and display tree 1140 in the tree view 1120 on an output device 170 (block 1740).

It should be noted that the some or all of a hierpath may be dropped into targets to navigate to portions of the targets that relate to the dropped hierpath. For example, the target may be an application, a document (e.g., a word processing document), a spreadsheet, a database (e.g., a requirements database), or some other target. Dropping the hierpath onto the target may automatically navigate to a portion of the target that corresponds to the hierpath. For example, if the target is a word processing document, the hierpath may navigate to a section in the word processing document that corresponds to the hierpath. Likewise, for example, if the target is a requirements database, dropping the hierpath in the requirements database may cause the product to navigate to a specific requirement (or set of requirements) in the requirements database.

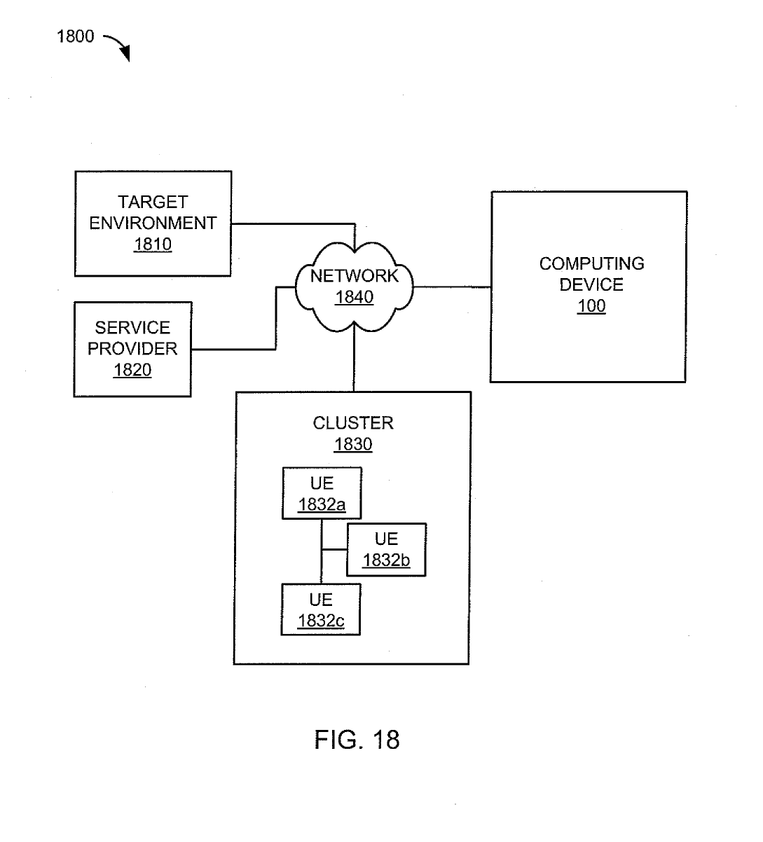

One or more embodiments may be implemented in a distributed environment. FIG. 18 illustrates an example of a distributed environment 1800 that may be configured to implement one or more embodiments of the invention. Referring to FIG. 18, environment 1800 may contain various entities including computing device 100, target environment 1810, service provider 1820, cluster 1830, and network 1840. Note that the distributed environment illustrated in FIG. 18 is just one example of an environment that may be used with embodiments of the invention. Other distributed environments that may be used with embodiments of the invention may contain more entities, fewer entities, entities in arrangements that differ from the arrangement illustrated in FIG. 18, and so on. Moreover, one or more distributed environments, that may be used with one or more embodiments of the invention, may be configured to implement various cloud-computing frameworks.

Details of computing device 100 were described above with respect to FIG. 1. In distributed environment 1800, computing device 100 may be configured to, among other things, exchange information (e.g., data) with other entities (e.g., target environment 1810, service provider 1820, and cluster 1830) in network 1840. Computing device 100 may interface with the network 1840 via communication interface 180.

The network 1840 may include a communication network capable of exchanging information between the entities in the network 1840. The network 1840 may include digital and/or analog aspects. The information may include machine-readable information having a format that may be adapted for use, for example, in the network 1840 and/or with one or more entities in the network 1840. For example, the information may be encapsulated in one or more packets that may be used to transfer the information through the network 1840.

Information may be exchanged between entities using various network protocols, such as, but not limited to, the Internet Protocol (IP), Asynchronous Transfer Mode (ATM), Synchronous Optical Network (SONET), the User Datagram Protocol (UDP), Transmission Control Protocol (TCP), Institute of Electrical and Electronics Engineers (IEEE) 802.11, or other network protocol.

The network 1840 may include various network devices, such as gateways, routers, switches, firewalls, servers, repeaters, address translators, or other network device. Portions of the network 1840 may be wired (e.g., using wired conductors, optical fibers, etc.) and/or wireless (e.g., using free-space optical (FSO), radio frequency (RF), acoustic transmission paths, etc.). Portions of network 1840 may include a substantially open public network, such as the Internet. Portions of the network 1840 may include a more restricted network, such as a private corporate network or virtual private network (VPN). It should be noted that implementations of networks and/or devices operating on networks described herein are not limited with regards to information carried by the networks, protocols used in the networks, the architecture/configuration of the networks, etc.

The service provider 1820 may include logic (e.g., software, and/or hardware) that makes a service available to another entity in the distributed environment 1800. The service provider 1820 may also include a server operated by, for example, an individual, a corporation, an educational institution, a government agency, and so on, that provides one or more services to a destination, such as computing device 100. The services may include software containing computer-executable instructions that implement one or more embodiments of the invention or portions thereof, and may be executed, in whole or in part, by (1) a destination, (2) the service provider 1820 on behalf of the destination, or (3) some combination thereof.

For example, in an embodiment, service provider 1820 may provide one or more subscription-based services that may be available to various customers. The services may be accessed by a customer via network 1840. The customer may access the services using a computing device, such as computing device 100. The services may include services that implement one or more embodiments of the invention or portions thereof. The service provider 1820 may limit access to certain services based on, e.g., a customer service agreement between the customer and the service provider 1820.

The service agreement may allow the customer to access the services that may allow the customer to build, execute, and/or analyze a model, such as model 300, as described above. The service agreement may include other types of arrangements, such as certain fee-based arrangements or restricted access arrangements. For example, a customer may pay a fee which provides the customer unlimited access to a given package of services for a given time period (e.g., per minute, hourly, daily, monthly, yearly, etc.). For services not included in the package, the customer may have to pay an additional fee in order to access the services. Still other arrangements may be resource-usage based. For example, the customer may be assessed a fee based on an amount of computing resources or network bandwidth used.

Cluster 1830 may include a number of units of execution (UEs) 1832 that may perform processing of one or more embodiments of the invention or portions thereof on behalf of computing device 100 and/or another entity, such as service provider 1820. The UEs 1832 may reside on a single device or chip or on multiple devices or chips. For example, the UEs 1832 may be implemented in a single ASIC or in multiple ASICs. Likewise, the UEs 1832 may be implemented in a single computing device or multiple computing devices. Other examples of UEs 1832 may include FPGAs, CPLDs, ASIPs, processors, MPSoCs, graphic processing units, virtual machines, microprocessors, etc.

The UEs 1832 may be configured to perform operations on behalf of another entity. For example, in an embodiment, the UEs 1832 are configured to execute portions of code associated with the ME 200. Here, the ME 200 may dispatch certain activities pertaining to one or more embodiments of the invention to the UEs 1832 for execution. The service provider 1820 may configure cluster 1830 to provide, for example, the above-described services to computing device 100 on a subscription basis (e.g., via a web service).

It should be noted that one or more embodiments of the invention may be implemented in environments other than an ME and may be used to navigate hierarchies other than model hierarchies. For example, one or more embodiments of the invention may be implemented in an integrated development environment (IDE), an application, operating system, etc. Other hierarchies that may be navigated using one or more embodiments of the invention may include, for example, file systems, software objects, databases, etc.

The foregoing description of embodiments is intended to provide illustration and description, but is not intended to be exhaustive or to limit the invention to the precise form disclosed. Modifications and variations are possible in light of the above teachings or may be acquired from practice of the invention. For example, while a series of acts has been described above with respect to FIGS. 13-17, the order of the acts may be modified in other implementations. Further, non-dependent acts may be performed in parallel.

Also, the term “user”, as used herein, is intended to be broadly interpreted to include, for example, a computing device or a user of a computing device, unless otherwise stated.

It will be apparent that embodiments, described herein, may be implemented in many different forms of software and/or hardware. Software code and/or specialized hardware used to implement embodiments described herein is not limiting of the invention. Thus, the operation and behavior of embodiments were described without reference to the specific software code and/or specialized hardware—it being understood that one would be able to design software and/or hardware to implement the embodiments based on the description herein.

Further, certain embodiments of the invention may be implemented as “logic” that performs one or more functions. This logic may be hardware-based, software-based, or a combination of hardware-based and software-based. The logic may be stored in one or more computer-readable storage media and may include computer-executable instructions for execution by processing logic, such as processing logic 120. The computer-executable instructions may be configured to implement one or more embodiments of the invention. The computer-readable storage media may be volatile or non-volatile and may include, for example, flash memories, removable disks, non-removable disks, and so on.

No element, act, or instruction used herein should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. One or more computer-readable storage media for storing computer-executable instructions executable by processing logic, the media storing one or more instructions for:
providing a navigation widget in a modeling environment, the navigation widget displaying a first hierpath, the first hierpath indicating a path to a first portion of a model;
receiving input, via the navigation widget, that is associated with a second hierpath, the second hierpath indicating a path to a second portion of the model; and
in response to receiving the input, displaying a view of the second portion of the model.

2. The media of claim 1 wherein the input is text information that specifies at least a portion of the second hierpath.

3. The media of claim 2 further storing one or more instructions for:
identifying a possible completion of the second hierpath based on the text information.

4. The media of claim 3 further storing one or more instructions for:
displaying the identified possible completion of the second hierpath; and
receiving a selection of the identified possible completion of the second hierpath.

5. The media of claim 1 wherein the displayed view of the second portion of the model is at least one of a block diagram view, code view, requirements view, message sequence chart view, software component view, data type conversion view, dependency view, workspace view, mask workspace view, differencing view, revision view, variants view, or custom view.

6. The media of claim 1 further storing one or more instructions for:
receiving an indication of the second hierpath being positioned over a structural tree display of the model; and
updating the structural tree display of the model based on the second hierpath.

7. The media of claim 1 further storing one or more instructions for:
receiving an indication of the second hierpath being positioned over a target; and
navigating to a portion of the target associated with the hierpath.

8. The media of claim 7 wherein the target is a document, a database, or a spreadsheet.

9. The media of claim 1 wherein the first hierpath includes one or more hyperlinks that represent one or more levels in the path represented by the first hierpath, and wherein receiving an input further comprises:
receiving a selection of a hyperlink in the one or more hyperlinks, the received selection representing a lowest level of the second hierpath.

10. The media of claim 1 wherein the model is a graphical model, a textual model, or a combination of a graphical model and textual model.

11. The media of claim 1 wherein the model is at least one of:
a time-based graphical block diagram model, a state transition diagram, a discrete event model, an activity diagram, a Unified Modeling Language (UML) diagram, a sequence diagram, a data flow model.

12. The media of claim 1 wherein the first hierpath or the second hierpath includes at least one of an icon or text.

13. One or more computer-readable storage media for storing computer-executable instructions executable by processing logic, the media storing one or more instructions for:
receiving a selection of an entity displayed in a view of a first portion of a model;
receiving an indication, via a displayed hierpath provided by a navigational widget, that the selected entity is to be added to a second portion of the model that is at a different level of a hierarchy of the model than the first portion of the model, the displayed hierpath containing a path to the second portion of the model; and
adding the selected graphical entity to the second portion of the model.

14. The media of claim 13 further comprising one or more instructions for:
adding a link between the selected graphical entity and the graphical entity added to the second portion of the model.

15. The media of claim 13 wherein the indication includes moving the selected entity over the displayed hierpath.

16. The media of claim 13 further comprising one or more instructions for:
displaying a view of the second portion of the model containing the selected entity.

17. The media of claim 13 further storing one or more instructions for:
removing the selected entity from the first portion of the model.

18. The media of claim 13 wherein the entity is a graphical block.

19. A method comprising:
providing, using a computing device, a navigation widget in a modeling environment, the navigation widget displaying a first hierpath, the first hierpath being associated with a path to a first portion of a model;
receiving, using the computing device, input, via the navigation widget, that is associated with a second hierpath, the second hierpath being associated with a path to a second portion of the model; and
in response to receiving the input, displaying, using the computing device, a view of the second portion of the model.

20. The method of claim 19 wherein the displayed view of the second portion of the model is at least one of a code view, requirements view, message sequence chart view, software component view, data type conversion view, dependency view, workspace view, mask workspace view, different version view, variants view, or custom view based on mode.

21. The method of claim 20 further comprising:
receiving, using the computing device, an indication of the second hierpath being positioned over a structural tree display of the model; and
updating, using the computing device, the structural tree display of the model based on the second hierpath.

22. The method of claim 20 wherein the first hierpath includes one or more hyperlinks that represent one or more levels in the path represented by the first hierpath, and wherein receiving an input further comprises:
receiving, using the computing device, a selection of a hyperlink in the one or more hyperlinks, the received selection representing the second hierpath.

23. A system comprising:
an output device; and
a processor configured to:
provide a navigation widget in a modeling environment, the navigation widget displaying a first hierpath, the first hierpath being associated with a path to a first portion of a model,
receive input, via the navigation widget, that is associated with a second hierpath, the second hierpath being associated with a path to a second portion of the model, and
in response to receiving the input, output a view of the second portion of the model to the output device.

24. The system of claim 23 wherein the output device is a display device.

25. An apparatus comprising:
means for providing a navigation widget in a modeling environment, the navigation widget displaying a first hierpath, the first hierpath being associated with a path to a first portion of a model;
means for receiving input, via the navigation widget, that is associated with a second hierpath, the second hierpath being associated with a path to a second portion of the model; and
means for displaying a view of the second portion of the model.

26. One or more computer-readable storage media for storing computer-executable instructions executable by processing logic, the media storing one or more instructions for:
displaying a first hierpath, the first hierpath indicating a path to a first portion of a model, the first hierpath being displayed in a navigation widget;
displaying a list of one or more second hierpaths in response to selecting an item in the first hierpath;
receiving a selection of a second hierpath in the displayed list; and
navigating to a second portion of the model that is associated with the selected second hierpath.

27. The media of claim 26 further comprising one or more instructions for:
displaying a view of the second portion of the model.

28. The media of claim 26 wherein the view is at least one of a block diagram view, code view, requirements view, message sequence chart view, software component view, data type conversion view, dependency view, workspace view, mask workspace view, differencing view, revision view, variants view, or custom view.

29. The media of claim 26 further comprising one or more instructions for:
displaying the second hierpath, the displayed second hierpath indicating a history of navigation of the model.

30. One or more computer-readable storage media for storing computer-executable instructions executable by processing logic, the media storing one or more instructions for:
receiving an indication to display a dependency view of a model;
displaying the dependency view of the model;
receiving a selection of a first element and a selection of a second element in the dependency view; and
displaying one or more hierpaths that represent one or more dependencies between the selected first element and the selected second element.

31. The media of claim 30 further comprising one or more instructions for:
receiving a selection of a hierpath in the one or more displayed hierpaths; and
indicating a dependency, represented by the selected hierpath, in the dependency view.

32. The media of claim 31 wherein the dependency is indicated in the dependency view by at least one of highlighting, bolding, flashing, underlining, inverting, low-lighting, or coloring.
